(19) United States
(12) Patent Application Publication
(10) Pub. No.: US 2023/0207994 A1
(43) Pub. Date: Jun. 29, 2023

(54) MOLTEN METAL BATTERY SYSTEM WITH METAL PRODUCTION AND FLOW BATTERY MODES

(71) Applicant: Enlighten Innovations Inc., Calgary (CA)

(72) Inventors: Mykola Makowsky, Menlo Park, CA (US); Sai V. Bhavaraju, Broomfield, CO (US); Thomas R. Hinklin, Calgary (CA); Joshua D. Johnston, Westminster, CO (US); Daniel S. Taggart, Broomfield, CO (US); Byron J. Charbonneau, Foothills (CA); Mikhail D. Chauvet, Red Deer (CA); Darsey S. Godwin, Calgary (CA)

(73) Assignee: Enlighten Innovations Inc., Calgary (CA)

(21) Appl. No.: 18/090,030

(22) Filed: Dec. 28, 2022

Related U.S. Application Data
(60) Provisional application No. 63/294,658, filed on Dec. 29, 2021.

(51) Int. Cl. H01M 50/588; H01M 10/39; H01M 50/51; H01M 4/36; H01M 4/38; H01M 10/42

(52) U.S. Cl. CPC H01M 50/588; H01M 10/39; H01M 50/51; H01M 4/368; H01M 4/381; H01M 10/4207; H01M 2004/027

(57) ABSTRACT

A molten metal battery system includes a plurality of secondary cells electrically connected in series with each other and comprising a plurality of molten metal anodes arranged fluidly in parallel with each other. The system also includes a plurality of electrically isolated molten metal reservoirs, each of the molten metal reservoirs fluidly connected to a corresponding secondary cell of the plurality of secondary cells and configured to exchange molten metal with the corresponding secondary cell while preventing electrical shunt current from flowing between the plurality of secondary cells via the molten metal.

### CROSS-REFERENCE TO RELATED PATENT APPLICATIONS

This application claims priority to and the benefit of U.S. Provisional Application No. 63/294,658 filed on Dec. 29, 2021 which is incorporated herein by reference.

### BACKGROUND

The present disclosure relates generally to electro-chemical batteries and more particularly to electro-chemical battery systems that use molten sodium or other molten metal. Batteries are known devices that are used to store and release electrical energy for a variety of purposes. In order to produce electrical energy, batteries typically convert chemical energy directly into electrical energy. Generally, a single battery includes one or more galvanic cells, wherein each of the cells is made of two half-cells that are electrically isolated except through an external circuit. During discharge, electrochemical reduction occurs at the cell's positive electrode, while electrochemical oxidation occurs at the cell's negative electrode. While the positive electrode and the negative electrode in the cell do not physically touch each other, they are generally chemically connected by one or more ionically conductive and electrically insulative electrolytes, which can either be in a solid or a liquid state, or in combination. When an external circuit, or a load, is connected to a terminal that is connected to the negative electrode and to a terminal that is connected to the positive electrode, the battery drives electrons through the external circuit, while ions migrate through the electrolyte.

Batteries can be classified in a variety of manners. For example, batteries that are completely discharged only once are often referred to as primary batteries or primary cells. In contrast, batteries that can be discharged and recharged more than once are often referred to as secondary batteries or secondary cells. A flow battery or redox flow battery is a type of secondary cell where chemical energy is provided by two chemical components dissolved in liquids (i.e., an anolyte and a catholyte) that are pumped through the system on separate sides of an ion-selective membrane. Ion exchange occurs through the membrane while the anolyte and the catholyte circulate in their own respective spaces on opposite sides of the membrane. The ion exchange is accompanied by a flow of electric current into or out of electrodes (i.e., an anode and a cathode) located at least partially within the anolyte and catholyte respectively. The anolyte and the catholyte are typically ionically conductive and electrically insulative electrolytes that facilitate ion exchange but do not conduct significant electric current. As such, the fluid circuits through which the anolyte and the catholyte flow can pass through multiple battery cells without causing electric current to flow between the battery cells via the anolyte or the catholyte fluids.

A molten sodium battery is a specialized type of secondary cell that replaces both the anode and the anolyte of a conventional secondary cell with molten sodium metal (elemental symbol Na). One example of a molten sodium battery is described in detail in U.S. Pat. No. 10,020,543 granted Jul. 10, 2018, the entire disclosure of which is incorporated by reference herein. When discharging a molten sodium battery, positively charged sodium ions or cations (Na⁺) are separated from electrons (e) within the sodium metal on the anode side of the membrane. The Na⁺ ions pass through the ion-selective membrane and react with the catholyte on the opposite side of the membrane while the electrons are driven through an external circuit. The opposite reaction occurs when charging the molten sodium battery. The Na⁺ ions pass through the ion-selective membrane from the catholyte and join with electrons on the anode side of the membrane to form sodium metal.

In some battery systems, it is desirable to electrically connect multiple battery cells in series with each other such that the individual cell voltages provided by the battery cells stack to provide a greater voltage for the battery system as a whole. The principle of electrically connecting multiple battery cells in series can be readily applied to most types of batteries including flow batteries. A flow battery constructed in this manner typically has a single catholyte fluid circuit that circulates the catholyte through the cathode side of each battery cell, which can be arranged fluidly in parallel or fluidly in series with each other. Similarly, the flow battery may include a single anolyte fluid circuit that circulates the anolyte through the anode side of each battery cell, which can be arranged fluidly in parallel or fluidly in series with each other.

However, attempting to connect multiple molten sodium battery cells in series with each other can be challenging because the molten sodium metal has a high electrical conductivity (i.e., approximately 1×10⁶ mS/cm at 98° C.) which is several orders of magnitude higher than the electrical conductivities of conventional battery electrolytes (i.e., approximately 500 mS/cm at 50° C. for conventional aqueous electrolytes, approximately 50 mS/cm at 115° C. for conventional non-aqueous or organic electrolytes). This can be problematic because electric current can flow between the molten sodium battery cells via the molten sodium metal, which equalizes the electric potential (i.e., voltage) across the battery cells and prevents the cell voltages from stacking when electrically connected in series. The present disclosure addresses these and other challenges that arise in molten sodium battery systems.

### SUMMARY

One implementation of the present disclosure is a molten metal battery system. The system includes a plurality of secondary cells electrically connected in series with each other and having a plurality of molten metal anodes arranged fluidly in parallel with each other. The system includes a plurality of electrically isolated molten metal reservoirs. Each of the molten metal reservoirs is fluidly connected to a corresponding secondary cell of the plurality of secondary cells and configured to exchange molten metal with the corresponding secondary cell while preventing electrical shunt current from flowing between the plurality of secondary cells via the molten metal.

In some embodiments, the molten metal includes molten sodium metal.

In some embodiments, the molten metal flows passively between the plurality of electrically isolated molten metal reservoirs and the plurality of secondary cells without requiring a powered component to drive flows of the molten metal.

In some embodiments, the system includes a molten metal distributor fluidly connected in series between an external molten metal source and the plurality of secondary cells and configured to distribute the molten metal from the external molten metal source to the plurality of molten metal anodes while preventing the electrical shunt current from flowing between the plurality of secondary cells via the molten metal.

In some embodiments, the molten metal distributor includes a molten metal distribution drip feeder configured to release droplets of the molten metal from an upper portion of the molten metal distributor and allow the droplets of the molten metal to fall through an electrically insulating fluid within the molten metal distributor into a plurality of electrically isolated compartments located along a lower portion of the molten metal distributor.

In some embodiments, the molten metal distributor includes a molten metal inlet fluidly connected to the external metal source and configured to receive the molten metal into the molten metal distributor from the external metal source, a plurality of compartments electrically isolated from each other, and a plurality of molten metal outlets each fluidly connected to a corresponding compartment of the plurality of compartments and configured to deliver the molten metal from the corresponding compartment to a corresponding secondary cell of the plurality of secondary cells.

In some embodiments, the molten metal distributor includes a plurality of electrically isolating fittings coupled to the plurality of molten metal outlets and configured to prevent electrical shunt current from flowing between the plurality of secondary cells via a structure of the molten metal distributor.

In some embodiments, the plurality of secondary cells are configured to operate as a flow battery in a charging mode in which the plurality of secondary cells consume electricity and produce the molten metal within the plurality of molten metal anodes and in a discharging mode in which the plurality of secondary cells consume the molten metal within the plurality of molten metal anodes and produce electricity.

In some embodiments, each of the plurality of secondary cells includes a cathode compartment containing a catholyte fluid, an anode compartment containing a molten metal anode of the plurality of molten metal anodes, and an ion-selective membrane positioned between the cathode compartment and the anode compartment and configured to selectively transport metal ions between the cathode compartment and the anode compartment.

In some embodiments, the plurality of secondary cells are configured to operate in a charging mode including transporting the metal ions from the cathode compartment, through the ion-selective membrane, to the anode compartment, and reducing the metal ions within the anode compartment by combining the metal ions with electrons to produce the molten metal.

In some embodiments, the plurality of secondary cells are configured to operate in a discharging mode including oxidizing the molten metal within the anode compartment to form the metal ions and discharge electrons and transporting the metal ions from the anode compartment, through the ion-selective membrane, to the cathode compartment.

In some embodiments, the system includes an isolation plate located between adjacent secondary cells of the plurality of secondary cells and configured to electrically isolate the adjacent secondary cells from each other.

In some embodiments, the system includes a plurality of battery strings electrically connected in series with each other. Each battery string of the plurality of battery strings may include multiple unit cells including one of the plurality of secondary cells one or more additional secondary cells including one or more additional molten metal anodes.

In some embodiments, the multiple unit cells within each string are electrically connected in parallel with each other and the molten metal anodes within each string are maintained at substantially equal electrical potentials.

In some embodiments, each string of the plurality of strings includes a plurality of cathodes and a plurality of molten metal anodes arranged in an alternating sequence. At least one of the plurality of cathodes or the plurality of molten metal anodes may be shared by adjacent unit cells of the multiple unit cells.

Another implementation of the present disclosure is a molten metal battery system including a plurality of secondary cells electrically connected in series with each other and having a plurality of molten metal anodes arranged fluidly in parallel with each other. The system includes a molten metal storage vessel configured to store molten metal and a molten metal aggregator fluidly connected in series between the plurality of secondary cells and the molten metal storage vessel. The molten metal aggregator is configured to deliver the molten metal from the plurality of molten metal anodes to the metal storage vessel while preventing electrical shunt current from flowing between the plurality of secondary cells via the molten metal.

In some embodiments, the molten metal includes molten sodium metal.

In some embodiments, the molten metal flows passively between the plurality of secondary cells, the molten metal aggregator, and the molten metal storage vessel without requiring a powered component to drive flows of the molten metal.

In some embodiments, the molten metal aggregator includes a plurality of molten metal inlets, each molten metal inlet of the plurality of molten metal inlets fluidly connected to a corresponding secondary cell of the plurality of secondary cells and configured to receive the molten metal from the corresponding secondary cell. The molten metal aggregator may include a molten metal collection chamber configured to receive the molten metal from each of the plurality of molten metal inlets and combine the molten metal into a single pool. The molten metal aggregator may include a molten metal outlet fluidly connected to the molten metal storage vessel and configured to deliver the molten metal from the molten metal collection chamber to the molten metal storage vessel.

In some embodiments, the molten metal aggregator includes a plurality of electrically isolating fittings coupled to the plurality of molten metal inlets and configured to prevent electrical shunt current from flowing between the plurality of secondary cells via a structure of the molten metal aggregator.

In some embodiments, the molten metal aggregator includes a molten metal aggregation drip feeder configured to release droplets of the molten metal from an upper portion of the molten metal aggregator and allow the droplets of the molten metal to fall through an electrically insulating fluid into a molten metal collection chamber located along a lower portion of the molten metal aggregator.

In some embodiments, each of the plurality of secondary cells includes a cathode compartment containing a catholyte fluid, an anode compartment containing a molten metal anode of the plurality of molten metal anodes, and an ion-selective membrane positioned between the cathode compartment and the anode compartment and configured to selectively transport metal ions between the cathode compartment and the anode compartment.

In some embodiments, the plurality of secondary cells are configured to operate as a molten metal production system by transporting the metal ions from the cathode compartment, through the ion-selective membrane, to the anode compartment, reducing the metal ions within the anode compartment by combining the metal ions with electrons to produce the molten metal, and discharging the molten metal to the molten metal storage vessel.

In some embodiments, the system includes an isolation plate located between adjacent secondary cells of the plurality of secondary cells and configured to electrically isolate the adjacent secondary cells from each other.

In some embodiments, the system includes a plurality of battery strings electrically connected in series with each other. Each battery string of the plurality of battery strings may include multiple unit cells including one of the plurality of secondary cells one or more additional secondary cells including one or more additional molten metal anodes.

In some embodiments, the multiple unit cells within each string are electrically connected in parallel with each other and the molten metal anodes within each string are maintained at substantially equal electrical potentials.

In some embodiments, each string of the plurality of strings includes a plurality of cathodes and a plurality of molten metal anodes arranged in an alternating sequence. At least one of the plurality of cathodes or the plurality of molten metal anodes may be shared by adjacent unit cells of the multiple unit cells.

In some embodiments, the system includes a molten metal distributor fluidly connected in series between an external molten metal source and the plurality of secondary cells and configured to distribute the molten metal from the external molten metal source to the plurality of molten metal anodes while preventing the electrical shunt current from flowing between the plurality of secondary cells via the molten metal.

In some embodiments, the molten metal distributor includes a molten metal distribution drip feeder configured to release droplets of the molten metal from an upper portion of the molten metal distributor and allow the droplets of the molten metal to fall through an electrically insulating fluid within the molten metal distributor into a plurality of electrically isolated compartments located along a lower portion of the molten metal distributor.

In some embodiments, the molten metal distributor includes a molten metal inlet fluidly connected to the external metal source and configured to receive the molten metal into the molten metal distributor from the external molten metal source, a plurality of compartments electrically isolated from each other, and a plurality of molten metal outlets each fluidly connected to a corresponding compartment of the plurality of compartments and configured to deliver the molten metal from the corresponding compartment to a corresponding secondary cell of the plurality of secondary cells.

In some embodiments, the molten metal distributor includes a plurality of electrically isolating fittings coupled to the plurality of molten metal outlets and configured to prevent electrical shunt current from flowing between the plurality of secondary cells via a structure of the molten metal distributor.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a first perspective view of a molten sodium battery system (“the system”), according to some embodiments.

FIG. 2 is a second perspective view of the system, according to some embodiments.

FIG. 3 is a schematic diagram of electrical connections within the system, according to some embodiments.

FIG. 4 is a diagram of fluid flows in the system in a flow battery charging mode, according to some embodiments.

FIG. 5 is a diagram of fluid flows in the system in a flow battery discharging mode, according to some embodiments.

FIG. 6 is a diagram of fluid flows in the system in a sodium production mode, according to some embodiments.

FIG. 7 is a diagram of fluid flows through cells of a string of the system, according to some embodiments.

FIG. 8 is another diagram of fluid flows through cells of a string of the system, according to some embodiments.

FIG. 9 is a first perspective view of a sodium distributor of the system, according to some embodiments.

FIG. 10 is a second perspective view of the sodium distributor, according to some embodiments.

FIG. 11 is a first cut-away view of the sodium distributor, according to some embodiments.

FIG. 12 is a second cut-away view of the sodium distributor, according to some embodiments.

FIG. 13 is a perspective view of a sodium aggregator of the system, according to some embodiments.

FIG. 14 is a first cut-away view of the sodium aggregator of the system, according to some embodiments.

FIG. 15 is a second cut-away view of the sodium aggregator of the system, according to some embodiments.

FIG. 16 is a cut-away perspective view of a distributor that can be used with the system, according to some embodiments.

FIG. 17 is a diagram of fluid flows in the system in a first aggregated storage flow battery mode, according to some embodiments.

FIG. 18 is a diagram of fluid flows in the system in a second aggregated storage flow battery mode, according to some embodiments.

FIG. 19 is a diagram of a geographically distributed implementation of the features disclosed herein, according to some embodiments.

FIG. 20 is a diagram illustrating electro-chemical reactions which may occur when charging unit cells of the system, according to some embodiments.

FIG. 21 is a diagram illustrating electro-chemical reactions which may occur when discharging unit cells of the system, according to some embodiments.

### DETAILED DESCRIPTION

### Overview

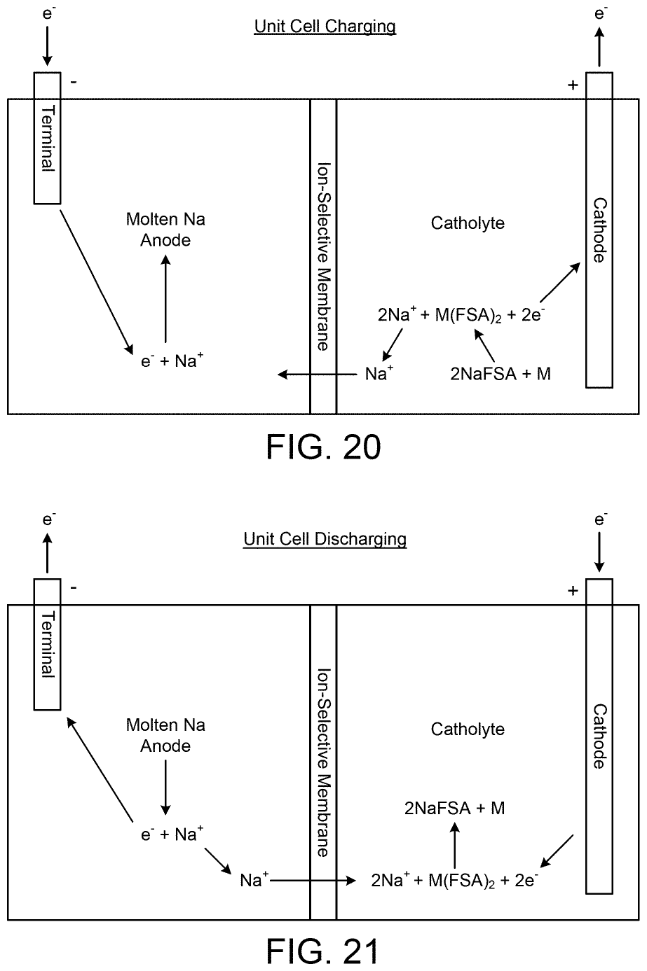

Referring generally to the figures, a molten sodium battery system and components thereof are shown, according to various exemplary embodiments. The molten sodium battery system may include a plurality of secondary cells (i.e., rechargeable battery cells), each of which includes a molten sodium metal anode, an ion-selective membrane (the term “membrane” used herein to refer to any suitable type of separator), and a cathode compartment through which a catholyte circulates (e.g., via an external pump). The ion-selective membrane is positioned between the molten sodium metal anode and the catholyte compartment and permits positively charged sodium cations (Na⁺) to pass through when charging or discharging the secondary cell. When discharging, the sodium ions cations (Na⁺) are separated from electrons (e) within the sodium metal on the anode side of the membrane, pass through the ion-selective membrane, and react with the catholyte on the opposite side of the membrane while the electrons are driven through an external circuit. When charging, the opposite reaction occurs; the Na⁺ ions pass through the ion-selective membrane from the catholyte and join with electrons (e) on the anode side of the membrane to form sodium metal (Na). This process is illustrated in FIGS. 20-21.

In some embodiments, multiple secondary cells (referred to herein as “unit cells,” “battery cells,” “secondary cells,” or like terms) are arranged in series and/or in parallel with each other to form a battery string (referred to herein as “strings,” “battery strings,” or like terms). Each battery string may include one or more unit cells. In some embodiments, the unit cells within a battery string are arranged electrically in parallel with each other. For example, a battery string may include 10 (or any number) of unit cells that each operate at 1.5 Volts (V) and 20 Amps (A) and can be electrically connected in parallel with each other such that the battery string has a combined voltage of 1.5V and electric current of 200 A. The sodium metal and catholyte fluid may flow through each of the unit cells within a battery string in parallel with each other, in series with each other, or any combination thereof. Multiple battery strings can be connected together to form a stack. For example, a stack may include 16 (or any number) of battery strings electrically connected in series with each other (e.g., via electrical bus bars) such that the stack has a stack voltage of 24V and electric current of 200 A. Although specific voltages and current values are provided herein as examples, it should be noted that these values can vary and should not be regarded as limiting. The sodium metal may flow through each of the battery strings within a stack in parallel with each other, whereas the catholyte fluid may flow through each of the battery strings within a stack in series with each other, in parallel with each other, or in any combination thereof.

The molten sodium battery system can operate in multiple modes including a flow battery mode and a sodium production mode. In both modes, each string receives a string-specific flow of priming sodium from a sodium distributor to initially fill or “prime” the unit cells. The sodium distributor may be configured to receive the sodium from an external sodium source and distribute the sodium to each of the strings in parallel with each other. Advantageously, the sodium distributor may be configured to keep the strings electrically isolated from each other by preventing electric current from flowing between the strings via the string-specific flows of priming sodium and/or via a structure (e.g., walls, surfaces, etc.) of the sodium distributor. Once the unit cells are primed with an initial amount of sodium, the sodium distributor is no longer needed. These and other features of the sodium distributor are described in greater detail below.

In flow battery mode, the molten sodium battery system can operate to charge the battery or discharge the battery. When charging the battery, electricity is consumed and Na⁺ ions pass through the ion-selective membrane from the catholyte and join with electrons (e) on the anode side of the membrane (i.e., within the molten sodium anode) to form sodium metal (Na) as described above. The sodium metal produced within the molten sodium anodes is forced out of the unit cells (e.g., as a result of the produced sodium occupying more volume within the sodium anode) via string-specific sodium outlets and flows into string-specific sodium reservoirs. In some embodiments, the string-specific sodium reservoirs are located physically above the battery strings (i.e., having higher gravitational potential energy) and serve as additional capacity to store the sodium metal produced when charging the battery. When discharging the battery, the opposite reaction occurs. Sodium metal flows into the molten sodium anodes of the unit cells from the string-specific sodium reservoirs and is consumed within the unit cells to produce sodium ions Na⁺ and electrons. The Na⁺ ions pass through the ion-selective membrane and react with the catholyte, while the electrons are discharged from the battery in the form of electricity. The string-specific sodium reservoirs are physically and electrically isolated from each other such that each string only provides sodium into a single sodium reservoir and receives sodium from that same sodium reservoir.

In sodium production mode, the molten sodium battery system operates in a manner similar to when the battery is charging in flow battery mode. Electricity is consumed and Na⁺ ions pass through the ion-selective membrane from the catholyte and join with electrons (e) on the anode side of the membrane (i.e., within the molten sodium anode) to form sodium metal (Na) as described above. The sodium metal produced within the molten sodium anodes is forced out of the unit cells via string-specific sodium outlets. However, in sodium production mode, the produced sodium does not need to be stored in string-specific sodium reservoirs. Instead of providing each string-specific flow of produced sodium to a separate reservoir, the string-specific flows of produced sodium are delivered to a sodium aggregator. The sodium aggregator receives a string-specific flow of sodium from multiple strings, aggregates (e.g., combines, collects, merges, etc.) the string-specific flows of sodium into a single sodium pool, and delivers the aggregated sodium to an external sodium storage vessel. Advantageously, the sodium aggregator may be configured to keep the strings electrically isolated from each other by preventing electric current from flowing between the strings via the string-specific flows of sodium and/or via a structure (e.g., walls, surfaces, etc.) of the sodium aggregator. These and other features of the sodium aggregator are described in greater detail below.

Although the battery system is described primarily as a molten sodium battery system throughout the present disclosure, it is contemplated that a variety of other molten alkali metals, other types of molten metals (i.e., non-alkali metals), molten metal alloys or eutectics, pure molten metals (i.e., not a mixture of multiple different metals), and/or other electrically conductive fluids, substances, or materials could be used in place of molten sodium metal without departing from the teachings provided herein. The specific types of chemicals, substances, and materials provided herein are examples that would be suitable for practicing the systems and methods of the present disclosure, but should not be regarded as limiting.

### Battery System

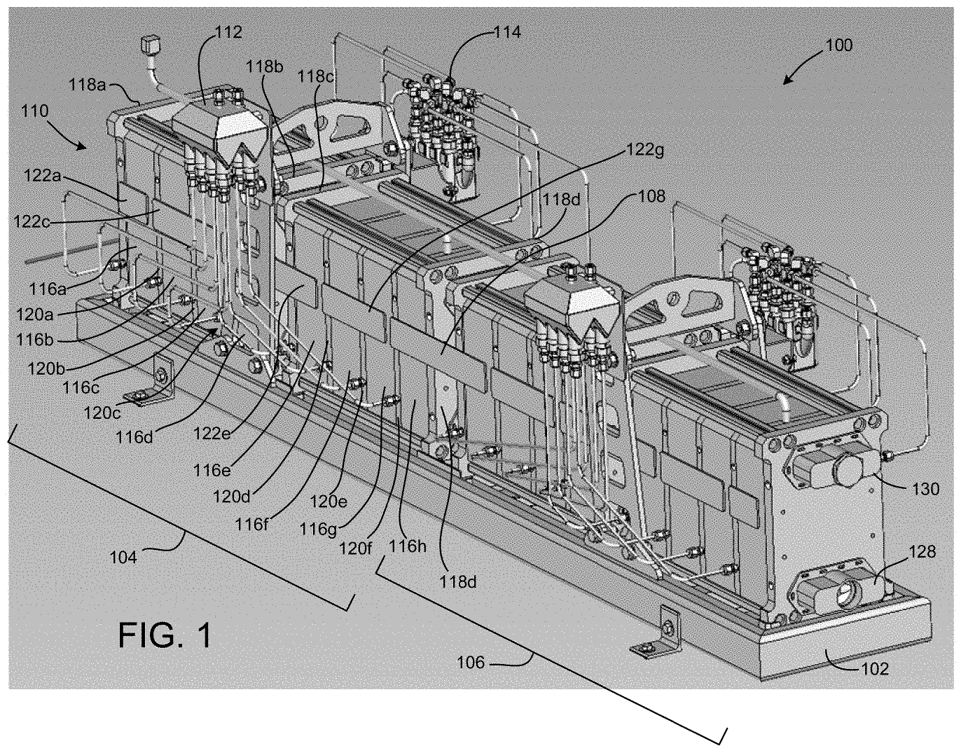

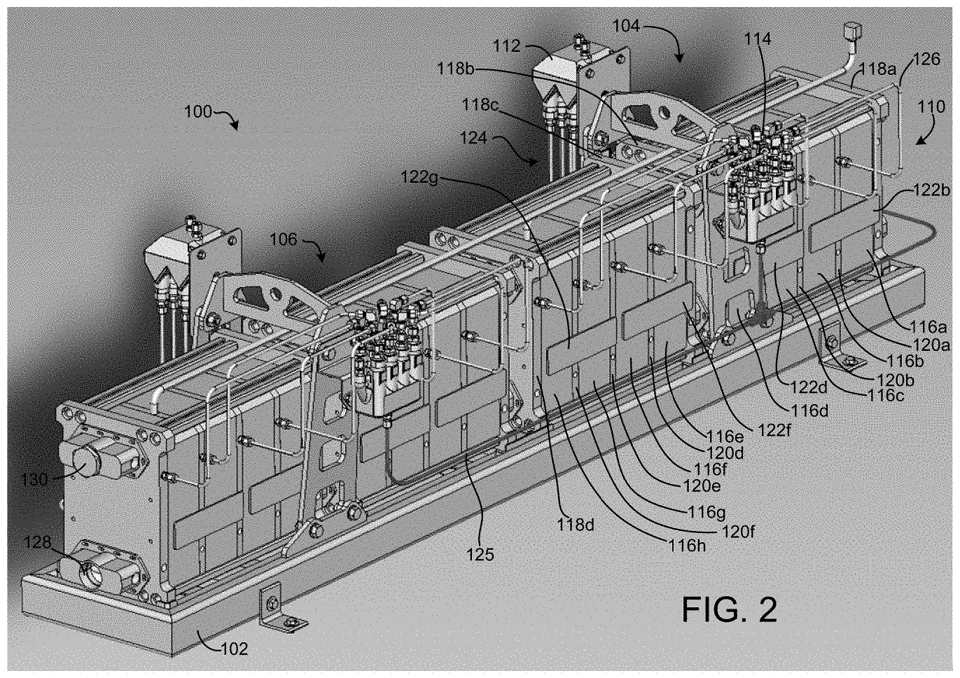

Referring now to FIGS. 1-2, perspective views of a system 100 is shown, according to some embodiments. The system 100 can be a flow battery system, a molten alkali metal battery system, a molten sodium battery system, an alkali metal production system, a sodium production system, etc. The system 100 is shown to include a base 102, a first subsystem 104 mounted on the base 102, and a second subsystem 106 mounted on the base 102. The first subsystem 104 and the second subsystem 106 may be connected in series by a first bus bar 108. The first subsystem 104 and the second subsystem 106 may be configured substantially the same.

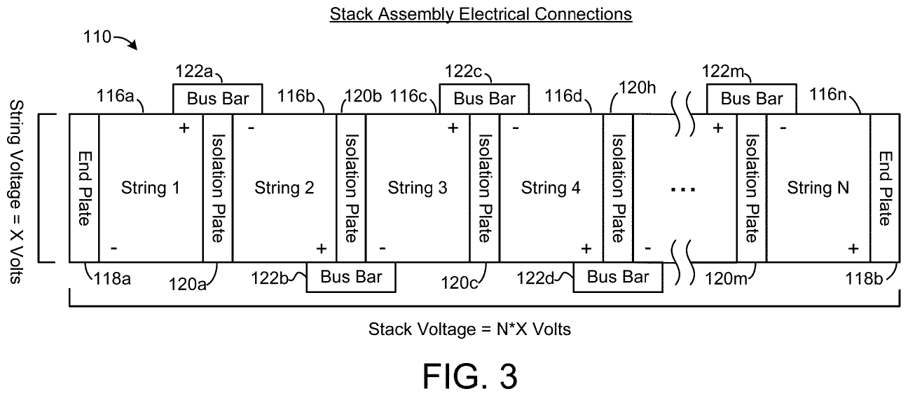

The first subsystem 104 is shown as including a stack assembly 110, a distributor 112 (e.g., sodium distributor, priming distributor), and an aggregator 114 (e.g., sodium aggregator, shunt break). The stack assembly 110 includes multiple strings 116 (shown as strings 116a-h). In the example shown, the strings 116 of stack assembly 110 are grouped in sets of four strings 116 (e.g., strings 116a-d and 116e-h) with each group of strings 116 bounded by end plates 118a-d. The strings 116 within each group are separated from each other by isolation plates 120 (shown isolation plates 120a-f) configured to fluidly and electrically isolate adjacent strings 116 from each other. The stack assembly 110 also includes bus bars 122 (shown as bus bars 122a-g) that provide electrical connections between the strings 116 (i.e., electrically connect the strings 116 in series with each other) as described in further detail with reference to FIG. 3.

Each string 116 includes a housing defined at least by an exterior wall which is visible in FIGS. 1-2. As shown in other figures and described with reference thereto, each string 116 includes one or more cells (e.g., battery cells, unit cells, secondary cells, etc.) which can charge to store electricity, for example by reducing sodium cations (i.e., adding an electron to an Na⁺ ion) to produce sodium atoms (Na), and discharge to produce electricity, for example by oxidizing sodium metal (i.e., splitting an electron from a sodium atom) to produce sodium cations Na⁺. The isolation plates 120 provide electrical isolation between neighboring strings 116. End plates 118 also provide electrical isolation and structural support for the stack assembly 110.

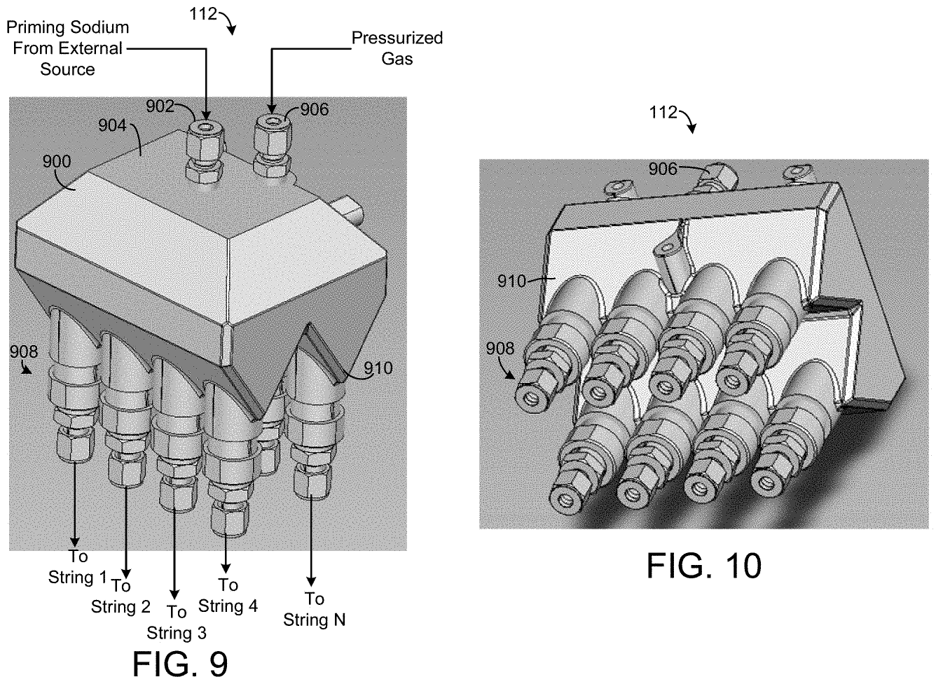

The distributor 112 is configured to distribute an electrically conductive fluid (e.g., fluid alkali metal, molten sodium) to the multiple strings 116 from a common source or inlet (e.g., an external sodium source) while providing for electrical isolation between the strings 116. The distributor 112 is connected to the multiple strings 116 by tubing 124 (e.g., one tube for each string 116a-g; eight tubes in the example shown) such that fluid can flow therebetween. As shown in FIGS. 1-2, the distributor 112 is mounted physically above the stack assembly 110 such that the force of gravity on the fluid in the distributor 112 will cause the fluid to flow downward toward/into the strings 116 and completely fill the strings 116a-g. Additional details of the distributor 112 and the electrical isolation provided thereby are described with reference to FIGS. 9-12.

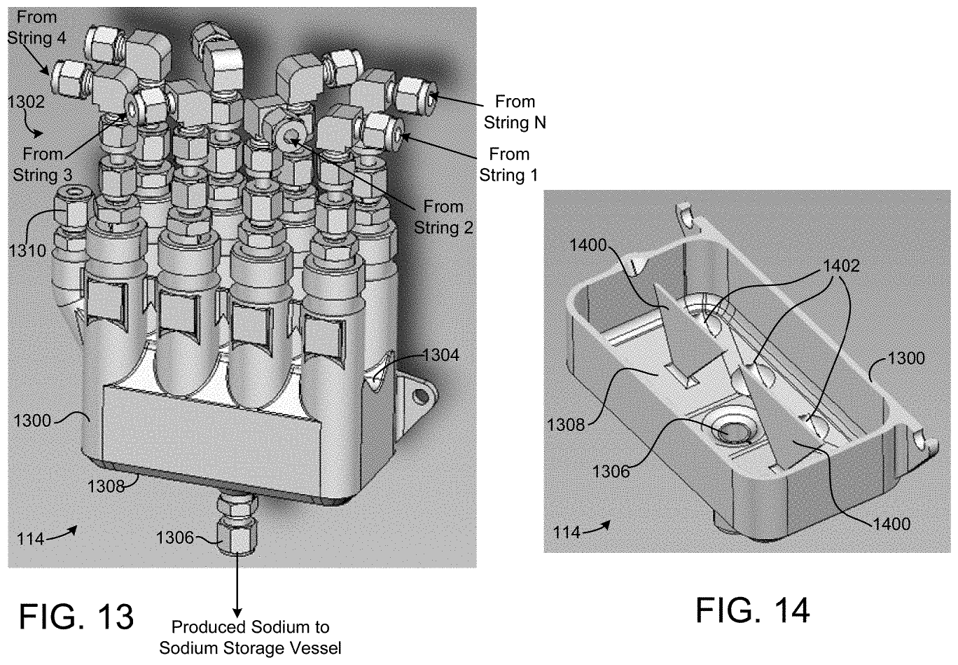

The aggregator 114 is configured to receive an electrically conductive fluid (e.g., fluid alkali metal, fluid sodium) from the multiple strings 116a-g and aggregate the electrically conductive fluid in a common receptacle or at a common outlet (e.g., via line 125) while providing for electrical isolation between the strings 116. The aggregator 114 is connected to the multiple strings 116 by tubing 126 (e.g., one tube for each string 116; eight tubes in the example shown) such that fluid can flow therebetween. As shown in FIGS. 1-2, the aggregator 114 is mounted physically above the stack assembly 110 such that the fluid is required to flow against the direction of gravity when flowing from the stack assembly 110 into the aggregator 114. This may occur as a result of the electrically conductive fluid being produced within the stack assembly 110 and forced out of the stack assembly as additional mass/volume of the electrically conductive fluid is produced. Details of the aggregator 114 and the electrical isolation provided thereby are provided below, for example with reference to FIGS. 13-16.

The distributor 112 and the aggregator 114 operate to deliver string-specific flows of the electrically conductive fluid to the strings 116 in parallel with each other and collect/aggregate string-specific flows of the electrically conductive fluid from the strings 116 in parallel with each other. The distributor 112 receives the electrically conductive fluid from an external source, divides the electrically conductive fluid into string-specific flows, and delivers the string-specific flows to the individual strings 116. Within the stack assembly 110, the string-specific flows of the electrically conductive fluid are maintained fluidly and electrically isolated from each other by the isolation plates 120 and end plates between adjacent strings 116 to prevent electrical current from flowing between adjacent strings 116 via the electrically conductive fluid. The aggregator receives string-specific flows of the electrically conductive fluid from the individual strings 116, combines or aggregates the string-specific flows into a single merged stream, and provides the merged stream of the electrically conductive fluid to an external storage vessel.

In some embodiments, the flows of the electrically conductive fluid between the distributor 112, the strings 116, the aggregator 114, and/or other components of system 100 occur passively and thus can be characterized as passive flows. Passive flows may include flows that are driven by gravity, naturally induced fluid currents (e.g., convection currents), displacement (e.g., fluid expansion or generation within the strings 116), or otherwise passively occur without requiring an active (e.g., powered) component such as a pump, compressor, fan, etc. to drive the flow. For example, the distributor 112, the external fluid source that feeds the distributor 112, and/or the string-specific reservoirs may be positioned above the strings 116 (e.g., directly above the strings 116 and/or an elevation above the strings 116 but horizontally to the side of the strings 116) such that the force of gravity causes the electrically conductive fluid to passively flow downward from such components into the strings 116 when space is available within the strings 116. This may occur when priming the strings 116 and/or when consuming the electrically conductive fluid within the strings 116 (e.g., during flow battery discharging mode) to free space within the strings 116. As another example, production of the electrically conductive fluid within the strings 116 (e.g., during sodium production mode or flow battery charging mode) may cause the mass of the electrically conductive fluid to increase within the strings 116. The increased mass of the electrically conductive fluid within the strings 116 may cause an increase in fluid pressure and/or volume within the strings 116, which may cause excess electrically conductive fluid that does not fit within the strings 116 to be forced out of the strings 116 by displacement. The displaced electrically conductive fluid may flow passively out of the strings 116 against the direction of gravity as additional mass of the electrically conductive fluid is produced within the strings 116 and into the aggregator 114 and/or external reservoirs positioned above the strings 116.

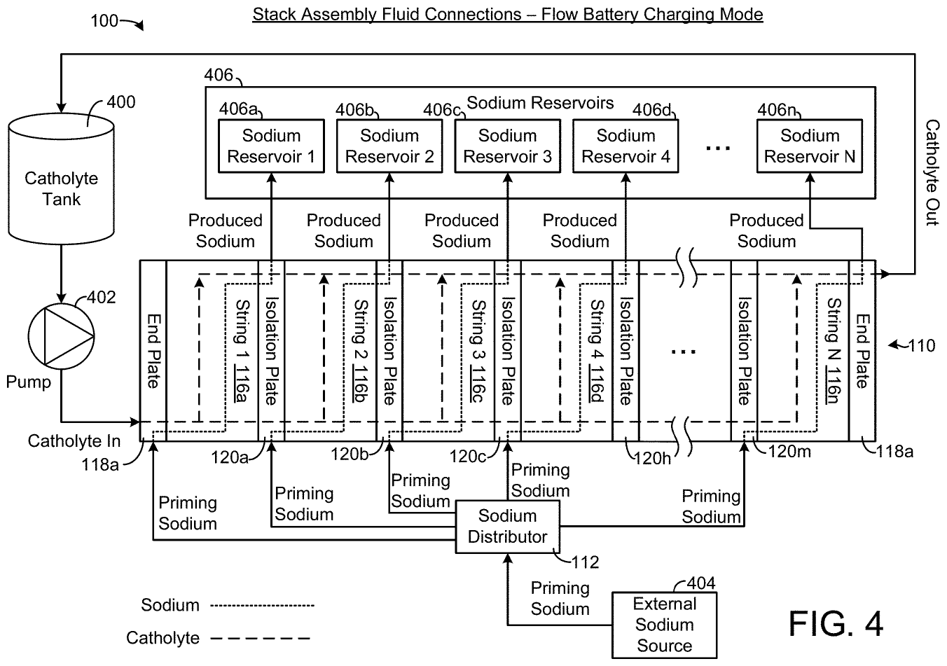

The second subsystem 106 is configured substantially the same as the first subsystem 106, and includes a comparable or identical stack assembly, distributor, and aggregator. As shown in FIGS. 1-2, an inlet port 128 and an outlet port 130 are positioned at one end of the second subsystem 106. In other embodiments, the inlet port 128 and the outlet port 130 are at opposite ends of the second subsystem 106. A similar inlet port and outlet port can be provided on end plate 118a and/or end plate 118d (e.g., an inlet port on end plate 118a and an outlet port on end plate 118d). The inlet port 128 provides an entry point for flow of a catholyte into the second subsystem and the outlet port 130 provides an exit point for flow of the catholyte out of the second subsystem. The catholyte may flow through cells of the system 100, as shown in FIGS. 4-8 and described with reference thereto.

The catholyte may include any suitable type of positive electrolyte or positive electrode solution. In some embodiments, the catholyte can be or include any type of fluid capable of exchanging ions (e.g., sodium ions or other cations) with the electrically conductive fluid. Examples of suitable catholytes include but are not limited to sodium sulfides, sodium halides, aluminum sulfides, aluminum halides, and/or any of the positive electrolytes or positive electrode solutions described in U.S. Pat. No. 10,734,686 granted Aug. 4, 2020, U.S. Pat. No. 8,968,902 granted Mar. 3, 2015, U.S. Patent Application Publication No. 2021/0280898 published Sep. 9, 2021, and/or U.S. Patent Application Publication No. 2021/0277529 published Sep. 9, 2021. The entire disclosure of each of these patents and patent application publications is incorporated by reference herein. The catholtye may flow through cathode compartments within the strings 116 and may fluidly contact one or more cathodes (i.e., positive electrodes) located at least partially within the cathode compartments. The cathodes may be made of or include any suitable cathode material including, for example, nickel, nickel oxyhydroxide (NiOOH), nickel hydroxide (Ni(OH)₂), sulfur composites, sulfur halides, including sulfuric chloride, any of the positive electrode materials described in any of the patents or patent application publications cited previously in this paragraph, and/or any other suitable positive electrode material.

In various embodiments, the catholyte flows through some or all of the strings 116 in series with each other, in parallel with each other, or any combination thereof. In some embodiments, catholyte has a significantly lower electrical conductivity than the electrically conductive fluid and does not need to be kept physically and electrically separate when flowing through the strings 116. Only a small current through the catholyte is expected (e.g., losses of less than one percent in some cases, which may vary depending on the orientation and arrangement of the strings 116 and/or the catholyte flow path). However, it is contemplated that similar isolation measures could be taken for the catholyte if an electrically conductive catholyte were used.

### Electrical Connections

Referring now to FIG. 3, a block diagram of electrical connections within the system 100 is shown, according to some embodiments. FIG. 3 shows an example stack assembly 110 with N strings 116 (where N is a positive integer) between a first end plate 118a and a second end plate 118b, with the strings 116 illustrated as String 1 116a, String 2 116b, String 3 116c, String 4 116d, up to String N 116. Any positive integer value of N is possible in various embodiments. As illustrated, each string 116 has a negative terminal (−) and a positive terminal (+). In some embodiments, each string 116 is configured to provide a voltage differential across the string 116, i.e., between the negative terminal (−) and the positive terminal (+). The voltage differential may be approximately 1.5 V in some implementations, and may have different magnitudes in various embodiments, uses, scenarios, etc. (e.g., X volts for each string 116).

Isolation plates 120 electrically isolate neighboring strings 116 from one another. As shown, a first isolation plate 120a electrically isolates String 1 116a from String 2 116b, a second isolation plate 120b electrically isolates String 2 116b from String 3 116c, a third isolation plate 120c electrically isolates String 3 116c from String 4 116d, a fourth isolation plate 120h electrically isolates String 4 116d from a subsequent string, an a M^{th} isolation plate 120m isolates String N 116N from preceding strings 116 (M=N−1). The isolation plates 120 thereby help prevent undesirable or unintended electric current flow (i.e., shunt current), voltage normalization, and/or other electrical interactions across the multiple strings 116.

FIG. 3 shows bus bars 122 connected to positive and negative terminals of neighboring strings 116 to connect the strings 116 in series. As shown, a first bus bar 122a connects the positive terminal of String 1 116a to the negative terminal of String 2 116b, around isolation plate 120a such that the only electrical connection between String 1 116a and String 2 116b is between the positive terminal of String 1 116a and the negative terminal of String 2 116b. A second bus bar 112b connects the positive terminal of String 2 112b to the negative terminal of String 3 116c, around isolation plate 120b, and so forth for bus bars 122c, d, h, . . . , m such that the strings 116 are connected in series with the positive terminal of each string connected to the negative terminal of the subsequent string up to String N 116n. For N strings 116, the embodiment of FIG. 3 includes M=N−1 bus bars 122.

When each of N strings 116 provides a voltage differential of X volts (where X can be any value, e.g., 1.5 V, 3 V, 12 V, 24 V, etc.), due to the series arrangement shown in FIG. 3 the voltage differential across the N strings 116 is approximately equal to N times X. The arrangement of strings 116 shown in FIG. 3 thereby enables the stack assembly 110 to provide or handle a voltage significantly larger than could be provided or handled by any individual string 116, for example. As described in detail below, the electrical arrangement of FIG. 3 can be used to provide an alkali metal production mode (e.g., sodium production mode) and charging and discharging flow battery modes with the system 100.

### Flow Battery Mode

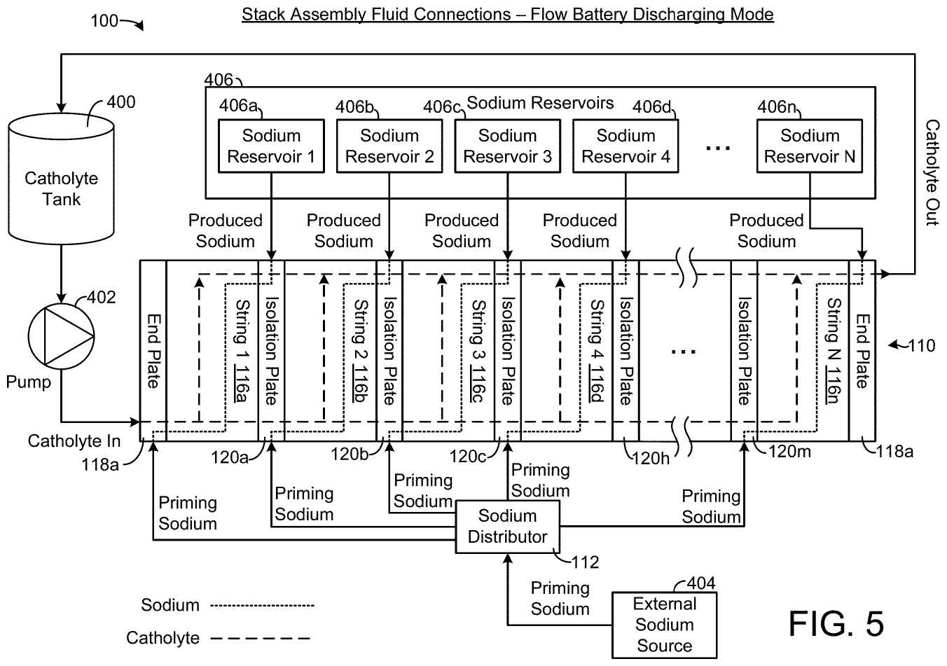

Referring now to FIGS. 4-5, fluid flows in the system 100 in flow battery charging modes and discharging modes are shown, according to some embodiments. When operating in flow battery charging mode (FIG. 4), the system 100 receives external electricity and converts the electricity into stored energy by producing and storing neutral sodium atoms (or some other similarly-reactive material, e.g., another alkali metal) by reducing positively charged cations (e.g., Na⁺). When operating in flow battery discharging mode (FIG. 5), the system 100 produces electricity through oxidation reactions that split electrons from the sodium atoms and transfer the sodium ions (Na⁺) to a catholyte. These modes are achieved in part by providing flow of sodium and catholyte through different compartments and conduits of the stack assembly 110, as described in further detail below.

The system 100 may further include components providing circulation of a catholyte through the system 100, for example a catholyte tank 400, a pump 402, and various tubing, conduits, etc. providing the flow pathways illustrated in FIG. 4. The catholyte tank 400 is configured to hold a catholyte fluid, and may provide agitation (e.g., stirring, mixing) of the catholyte fluid in some embodiments. The catholyte fluid can include or be made up of molecules suitable for giving up an Na⁺ ion during operation of the charging mode of FIG. 4 and to take on an Na⁺ ion during operation of the discharging mode of FIG. 5, for example as described in U.S. Pat. No. 10,020,543, the entire disclosure of which is incorporated by reference herein. The pump 402 operates to pump the catholyte from the catholyte tank 400, through and across the strings 116, and back to the catholyte tank 400. The pump 402 can be controlled to provide a constant flow rate of catholyte through the stack assembly 110, for example. The catholyte tank 400 stores or takes on excess or backup catholyte, for example enabling changes in total volume of the catholyte during charging and discharging operations.

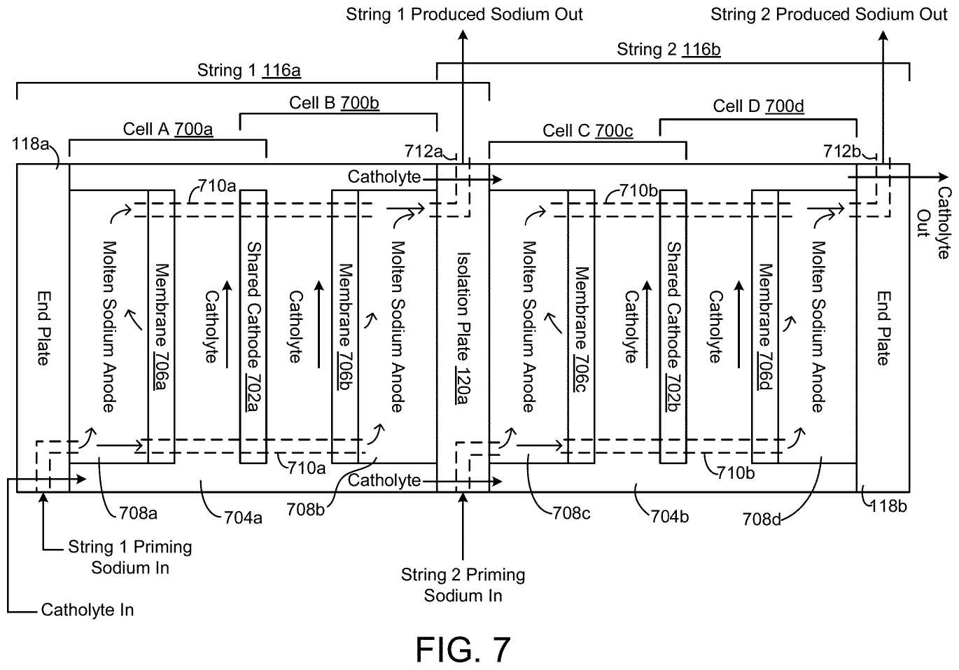

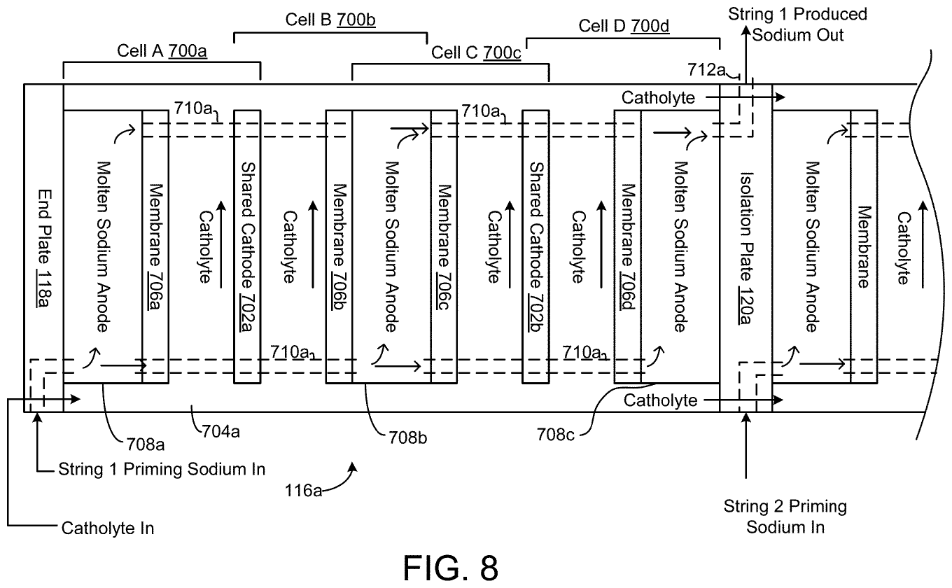

The catholyte is shown flowing through pathways in the strings 116. The pathways inside the strings 116 are illustrated in more detail in FIGS. 7-8. The catholyte flow paths are continuous through the strings 116, such that catholyte can flow through any of the strings 116 as it circulates through the system 100, driven by the pump 402. The catholyte is preferably electrically insulating, such that it does not provide a path for an electric current to flow between the strings 116 as the catholyte cycles through the system 100.

The system 100 also includes components facilitating flow of sodium into and out of the strings 116. In particular, the system 100 includes components (including the distributor 112 and external sodium source 404) for priming the strings 116 with an initial amount of sodium which is sufficient for initiation of the reactions which occur in the strings 116 and components (including sodium reservoirs 406) for storing sodium produced in the strings 116.

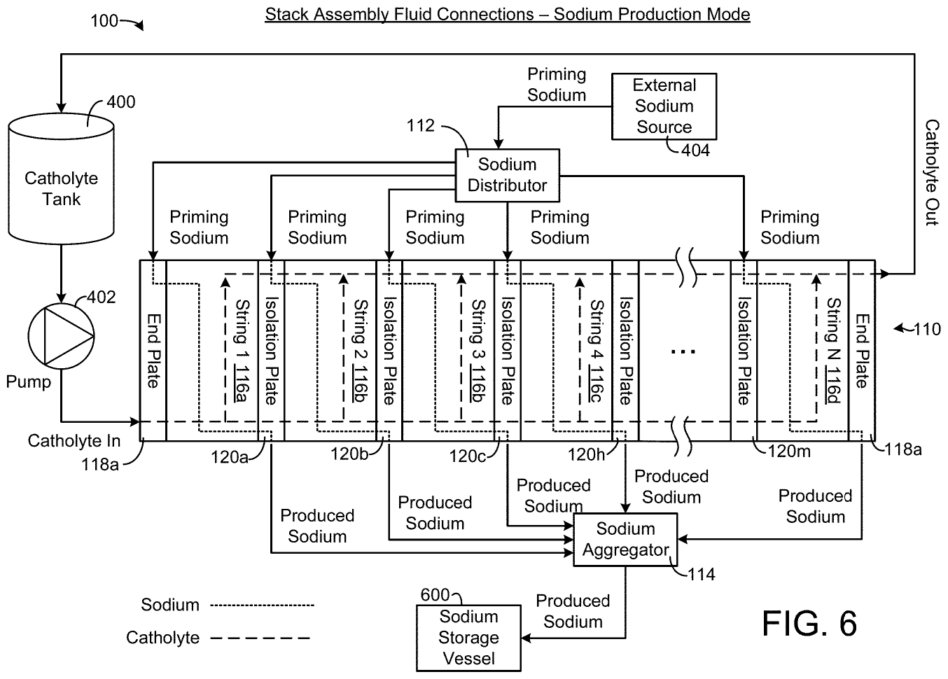

The external sodium source 404 can be any external source of sodium (or other suitable material in other embodiments) which is available (e.g., in a tank, reservoir, container) for use in priming the stack assembly 110. In some embodiments, the external sodium source 404 is the sodium storage vessel 600 shown in FIG. 6. The sodium distributor 112 is configured to obtain sodium from the external sodium source 404 (e.g., pumped into the sodium distributor 112 from the external sodium source 404, flows into the sodium distributor 112 via a gravity feed, transferred by pressure in the external sodium source 404, etc.) and distribute the sodium to the separate strings 116. Because, as illustrated in FIG. 3, the strings 116 are electrically arranged in series for the purposes of having voltage differentials across each string which combine to provide a larger voltage differential across the stack assembly 110, a challenge exists in preventing electrical conduction between the strings 116 via the sodium metal. Advantageously, the distributor 112 is configured to receive sodium from a unified source (e.g., via a single tube from the external sodium source 404) and distribute the sodium to separate lines running to the separate strings 116 while providing electrical isolation between the sodium in the separate lines. An example of the distributor 112 is shown in FIGS. 9-12 and described in detail with reference thereto below.

The sodium reservoirs 406 include separate reservoirs for each of the strings 116, such that each of the sodium reservoirs 406 receives sodium from one of the strings 116 without mixing, contact between, etc. the sodium from the separate strings 116. The sodium reservoirs 406 may be coupled together, for example sharing walls made of one or more non-conductive and sodium-compatible materials (e.g., polymethylpentene (PMP), steel coated with an electrically insulating coating), for example in arrangement having a common headspace and different compartments defining the sodium reservoirs 406. FIGS. 4-5 show Sodium Reservoir 1 406a connected to String 1 116a, Sodium Reservoir 2 406b connected to String 2 116b, Sodium Reservoir 3 406c connected to String 3 116c, Sodium Reservoir 4 406d connected to String 4 116d, through Sodium Reservoir N 406n connected to String N 116n. This arrangement electrically isolates the sodium from each string to prevent electric currents from flowing between the strings 116 via the sodium, as may occur in other designs.

In flow battery charging mode (illustrated in FIG. 4), the system 100 is first primed by the sodium distributor 112, which provides a starting amount of sodium from the external sodium source 404 into the strings 116. A voltage is applied across the stack assembly 110 by an external voltage source. The applied voltage provides a voltage differential across each of the strings 116. The pump 402 operates to cycle catholyte through the strings 116. The voltage differential across each of the strings 116 causes a Na⁺ cation to be pulled from the catholyte, through a membrane, and into an anode compartment where the Na⁺ cation combines with an electron (provided by a current from the external voltage source) to produce a sodium atom. This reaction continues to produce sodium atoms in each string 116, which causes an increase in volume of material in the sodium pathway in each string 116 and thereby forces sodium out of the strings 116 and into the respective sodium reservoirs 406. Sodium atoms are thereby produced and stored in the sodium reservoirs 406, causing the electricity to be stored in the form of electro-chemical energy.

In flow battery discharging mode (illustrated in FIG. 5), the system 100 operates to output electricity. Sodium flows from the sodium reservoirs 406 (e.g., from bottom draw ports or drip tubes) to the respective strings 116 (e.g., drawn into the strings 116 by gravity), where sodium atoms within the strings 116 lose an electron and Na⁺ cations flow across a membrane and into the catholyte, which continues to circulate by operation of pump 402. The excess electron moves to a cathode and thereby produces electricity that can flow out of the system 100. The system 100 is thereby configured to produce electricity from stored sodium atoms when operating in flow battery discharging mode.

### Sodium Production Mode

Referring now to FIG. 6, fluid flows in the system 100 in sodium production mode is shown, according to some embodiments. As in FIGS. 4-5, the sodium distributor 112 can operate to prime the sodium production mode by introducing an amount of sodium (shown as priming sodium in FIG. 6) from the external sodium source 404 into the strings 116. In the sodium production mode, the system 100 is arranged as shown in FIG. 6 and the sodium produced by the strings 116 (via reactions as described more fully with reference to FIGS. 7-8) flows separately to the sodium aggregator 114. The pump 402 operates to cycle catholyte through the stack assembly 110, including through the catholyte tank 400. In some embodiments, the catholyte tank 400 is a source of catholyte which provides sufficient catholyte for continuous operation of the system to produce sodium for an indefinite amount of time, e.g., by having a sufficiently large volume, by being refilled by an external source, etc.

The sodium aggregator 114 is configured to aggregate the sodium from the separate strings 116 into a single output to a sodium storage vessel 600. The sodium storage vessel 600 provides a single, unified space that receives sodium from all strings 116 (e.g., in contrast to the separate sodium reservoirs 406 of FIGS. 4-5). Sodium in the storage vessel 600 can then be removed as a valuable substance for other uses. Advantageously (and as detailed below with reference to FIGS. 13-16, the sodium aggregator 114 is configured to maintain electrical isolation between the sodium in each string 116 while aggregating sodium output by each string into a single, intermingled volume in the sodium storage vessel 600. By maintaining electrical isolation between the sodium in each string 116, no current can flow between the strings 116 through the sodium and the strings 116 can be held at different voltages. The sodium aggregator 114 thus plays an important role in enabling the series electrical connection between the strings 116 illustrated in FIG. 3.

In sodium production mode, produced sodium is removed from the stack assembly 110 via the sodium aggregator 114 and is prevented from flowing back into the strings 116 after production. This is a distinction relative to flow battery mode in which the produced sodium is permitted to flow back into the stack assembly 110 in flow battery discharging mode of FIG. 5. In both sodium production mode and flow battery mode, the sodium distributor 112 operates to provide sodium to the stack assembly 110 during a priming stage (and, in some scenarios for maintenance purposes), but is no longer needed after the unit cells have been primed (e.g., filled) with sodium during runtime of the sodium production mode. In some embodiments, the sodium distributor 112 can be fluidly disconnected from the stack assembly 110 after the unit cells have been primed (e.g., by closing valves, by disconnecting tubing, etc.) to further ensure that electrical current does not flow between the strings 116 via the sodium distributor 112 during an operational production stage of the sodium production mode or the flow battery mode. In some embodiments, the sodium storage vessel 600 can provide sodium to the external sodium source 404 for the use in future priming operations, or a single component could be used as both the sodium storage vessel 600 and the external sodium source 404 in other embodiments.

### String Construction

Referring now to FIG. 7, a diagram of example strings 116 of the system 100 is shown, according to some embodiments. In the example shown, each string 116 has two cells, shown in FIG. 7 as Cell A 700a and Cell B 700b of String 1 116a and Cell C 700c and Cell D 700d of Sting 2 116b. Each cell 700 can be characterized as a battery cell (i.e., a secondary cell, a unit cell, etc.). In each cell 700, catholyte is provided on an opposite side of a membrane from molten sodium (or other anode materials in other embodiments), such that a voltage can be produced across each cell 700 in a discharging mode or voltage across the cell 700 can be used to produce sodium (or otherwise store energy) in a charging mode. The membranes in the embodiments herein are selective of sodium ions and may be NaSICON or Beta alumina materials.

As shown in FIG. 7, the Cell A 700a and Cell B 700b are arranged for parallel fluid flow therethrough and such that Cell A 700a and Cell B 700b share a cathode (shared cathode 702a). That is, String 1 116a includes a catholyte chamber 704a through which catholyte can flow and which is filled with catholyte during operation of the system 110. The catholyte chamber 704a is divided by the shared cathode 702a, such that catholyte can flow in parallel along two sides of the cathode 702a. The catholyte chamber 704a is bounded by a first membrane 706a which separates the catholyte in the catholyte chamber 704a from a first anode chamber 708a of the string 116a, and by a second membrane 706b which separates the catholyte chamber 704 a from a second anode chamber 708b. The shared cathode 702a is positioned approximately equidistantly between the first membrane 706a and the second membrane 708a such that catholyte can flow through regions of catholyte chamber 704a between the first membrane 706a and the shared cathode 702a and between the second membrane 706b and the shared cathode 702a. Cell A 700a is defined by the combination of the first anode chamber 708a, the first membrane 706a, a portion of the catholyte chamber 704a, and the shared cathode 702a, while Cell B 700b is defined by the combination of the second anode chamber 708b, the second membrane 706b, a portion of the catholyte chamber 704a, and the shared cathode 702a. As such, the cathode 702a is shared between the adjacent unit cells 700a and 700b within String 1 116a.

String 1 116a is also shown to include sodium conduits (e.g., tubes, pipes, etc.) 710a that fluidly connect the first anode chamber 708a with the second anode chamber 708b. The sodium conduits 710a allow sodium (or other anode material) to flow through and between the anode chambers 708a-b of String 1 116a and to an outlet 712a positioned at the isolation plate 120a. As illustrated in FIG. 7, both the sodium and the catholyte may flow in parallel through each string 116, in the same direction, opposite directions, or any combination thereof.

String 2 116b is shown as being arranged substantially the same as String 116a, and includes corresponding components including a shared cathode 702b, a catholyte chamber 704b, a first membrane 706c, a second membrane 706d, a first anode chamber 708c, a second anode chamber 708d, conduits 710b, and outlet 712b. FIG. 7 illustrates that the catholyte chamber 704a of String 1 116a is in fluid communication with the catholyte chamber 704b of String 2 116b, such that catholyte can flow through the catholyte chamber 704a of String 1 116a into the catholyte chamber 704b of String 2 116b. FIG. 7 also illustrates that the anode chambers 708a,b and conduits 710a of String 1 are separate from (including electrically isolated from at least by the isolation plate 120a) the anode chambers 708c,d and conduits 710b of String 2 116b. Thus, catholyte is shared between String 1 116a and String 2 116b while the sodium (or other fluid anode) is kept isolated both electrically and fluidly from adjacent strings 116.

Referring now to FIG. 8, another view of strings 116 of the system 100 is shown, according to some embodiments. In the example shown in FIG. 8, each string 166, each string 116 includes four cells, shown as Cell A 700a, Cell B 700b, Cell C 700c, and Cell D 700d of String 1 116a. As in the example of FIG. 7, Cell A 700a and Cell B 700b are made up of a first shared cathode 702a portions of catholyte chamber 704a, a first membrane 706a, a second membrane 706b, a first anode chamber 708a, and a second anode chamber 708b arranged as described with reference to FIG. 7.

In the example of FIG. 8, String 1 116a is provided with additional cells (Cell C 700c and Cell D 700d) by using second anode chamber 708b to provide a shared anode between Cell B 700b and Cell C 700c. As shown, the second anode chamber 708b is delineated by the second membrane 706b and by a third membrane 706c. The third membrane 706c separates the second anode chamber 708b from a portion of the catholyte chamber 704a between the third membrane 706c and a second shared cathode 702b. The shared cathode 702b is an element of Cell C 700c and Cell D 700d. Cell D 700d also includes a third anode chamber 708c separated from the catholyte chamber 704a by a fourth membrane 706d such that catholyte can flow through the catholyte chamber 704a between the fourth membrane 706d and the second shared cathode 702b. As shown, String 1 116a thereby provides four cells using two cathodes and third anode chambers. Strings having any number of cells (e.g., 2, 3, 4, 5, 6, 7, 8, etc.) are within the scope of the present disclosure.

### Sodium Distributor

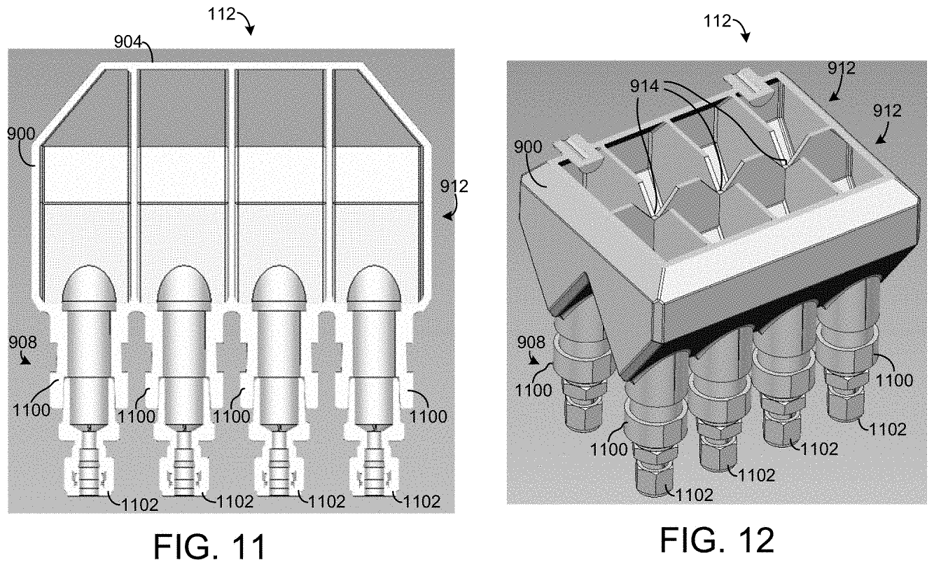

Referring now to FIGS. 9-12, various views of the distributor 112 are shown, according to some embodiments. The distributor 112 is connectable in series between an external sodium source 404 and the strings 116 of the system 100 and configured to distribute the fluid sodium from the external sodium source 404 to the strings 116 while preventing an electrical shunt current from flowing between the strings 116 via the molten sodium. FIG. 9 shows a first perspective view of the distributor 112, FIG. 10 shows a second perspective view of the distributor 112, FIG. 11 shows a first cut-away view of the distributor 112, and FIG. 12 shows a second cut-away view of the distributor 112.

As shown in FIGS. 9-12, the distributor 112 includes a chamber 900, a sodium inlet 902 positioned at a top wall 904 of the chamber 900, a gas inlet 906 positioned at a top wall 904 of the chamber 900, and multiple outlets 908 extending from a bottom wall 910 of the chamber 900 such the chamber 900 is arranged between the sodium inlet 902 and the multiple outlets 908. The chamber 900 is airtight, such that fluid can only enter or exit the interior of the chamber 900 via the sodium inlet 902, the gas inlet 906, and the outlets 908. The gas inlet 906 is connectable to a source of an inert gas that will not react with sodium and allows the inert gas to be provided into the chamber 900 (e.g., at a pressure higher than atmospheric pressure) to fill any space in the chamber 900 not occupied by sodium with a substance that will not react with the sodium. The chamber 900 may be made of a non-conductive material. The sodium inlet 902 is connectable to the external sodium source 404 (shown in FIGS. 4-6) and is configured to introduce sodium from the external sodium source 404 into the interior of the chamber 900. The sodium inlet 902 may regulate the rate of sodium flow or drip into the chamber 900. The sodium inlet 902 is shown as substantially centrally located on the top surface 904 of the chamber 900.

Each outlet 908 is shown as having a tubular or nozzle shape extending from the bottom surface 910 of the chamber 900. The outlets 908 may be made of an electrically insulating material. Each outlet 908 may be fluidly connected to a corresponding string 116 via the tubing 124 and configured to deliver sodium from distributor 112 to the corresponding string 116. As shown in FIGS. 9-12, the outlets 908 are arranged in two symmetric rows of four (eight total outlets 908), but other numbers of outlets 908 or other arrangements are also possible. The number of outlets 908 matches the number of strings 116 served by the distributor 112. Each outlet 908 may include a fitting 1100 made of an electrically insulating sodium-compatible material or other material (e.g., polytetrafluoroethylene (PTFE)) which electrically insulates the chamber 900 from a tip 1102 of each outlet 908. Accordingly, even if the tubes connecting the tips 1102 of each outlet 908 to the stack assembly 110 are exposed to different voltage levels, the electrical insulation provided by the fittings 1100 ensures that significant electric current does not flow between the strings 116 via the structure of the distributor 112.

In some embodiments, each outlet 908 includes a valve, flow restrictor, narrow region, nozzle, flared nozzle, drip-forming device, etc. such that fluid drips through an air gap between the chamber 900 and the tip 1102 of each outlet 908. The air gaps may provide electrical shunt breaks within the outlets 908 (i.e., between the chamber 900 and the tips 1102) to disrupt electrical shunt current from flowing between the strings 116 via the distributor 112. In some embodiments, the pressure of the pressurized gas provided to the distributor 112 via the gas inlet 906 can be controlled (e.g., adjusted, regulated, modulated, etc.) to facilitate the formation of droplets of the electrically conductive fluid at orifices that connect the chamber 900 to the outlets 908. For example, a controller can measure or calculate the pressure differential across the orifices and adjust the pressure of the pressurized gas provided via the gas inlet 906 (e.g., by operating a pump or other pressure control device) to maintain the pressure differential at a setpoint or target level that promotes droplet formation.

The chamber 900 includes multiple compartments 912, with each compartment 912 corresponding to and aligned with one of the outlets 908. The compartments 912 are defined by dividing walls that extend part way from the bottom wall 910 of the chamber 900 toward the top wall 904 of the chamber 900, leaving space between the top wall 904 of the chamber 900 and the compartments 912. The compartments 912 are electrically isolated (e.g., due to a material composition of the dividing walls) from one another, such that current will not flow between fluid in separate compartments 912 (when the fluid level is below the height of the compartments 912). For example, the chamber 900, the compartments 912, etc. may be made of a non-conductive material that is compatible or non-reactive with sodium (e.g., PMP). As seen in FIG. 12, the compartments 912 are connected by spill-over regions 914 at which a height of the compartments 912 is partially decreased at a shared corner of multiple compartments 912. The spill-over regions 914 facilitate distribution of fluid between the compartments 912 when the fluid level in the chamber 110 is above the spill-over regions 914. By providing a common headspace above the compartments 912 and in the chamber 900, a constant pressure can be regulated across the compartments 912 (e.g., by introduction of pressurized gas through the gas inlet 906) which can advantageously cause distribution out of the distributor 112 at constant drip rate or droplet size, in some embodiments. In some embodiments, the spill-over regions 914 may be replaced with a distributor plate located above the compartments 912 (e.g., within the common headspace) to equally distribute the fluid across the compartments 912. The distributor plate may be structured similar to distillation column trays (e.g., a planar surface with many small orifices distributed across the planar surface) such that the fluid pools above the distributor plate and flows (e.g., drips, streams, etc.) substantially evenly through the orifices into the compartments 912 located below.

### Sodium Aggregator

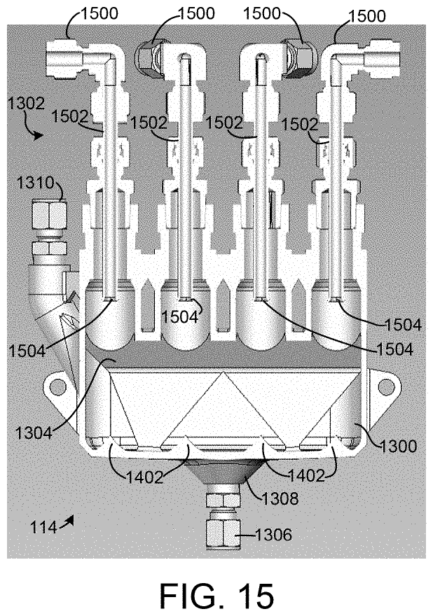

Referring now to FIGS. 13-15, multiple views of the aggregator 114 are shown, according to some embodiments. The aggregator 114 can be fluidly connected in series between the strings 116 and the sodium storage vessel 600 (as shown in FIG. 6) and configured to deliver fluid sodium from the strings 116 to the sodium storage vessel 600 while preventing electrical shunt current from flowing between strings 116 via the fluid sodium. FIG. 13 shows a first perspective view, FIG. 14 shows a first cut-away view, and FIG. 15 shows a second cut-away view.

The aggregator 114 is shown as including a chamber 1300 and multiple inlets 1302 extending upwardly from a top wall 1304 of the chamber 1300. The aggregator 114 also includes an outlet 1306 extending downwardly from a bottom wall 1308 of the chamber 1300, such that the chamber 1300 is between the inlets 1302 and the outlet 1306. The aggregator 114 also includes a gas inlet 1310 connected to the chamber 1300 and allowing introduction of an inert gas into the chamber 1300.

The outlet 1306 is shown as centrally located on the bottom wall 1308 of the chamber 1300, with the bottom wall 1308 sloped toward the outlet 1306 such that gravity pulls fluid in the chamber 1300 toward and into the outlet 1306. The bottom wall 1308 is also shown as including splash-prevention members 1402 (e.g., ridges, slopes, projections, etc.) arranged relative to the inlets 1302 to reduce or eliminate splashing of fluid that drips from the inlets 1302 into the chamber 1300. The chamber 1300 is shown as including internal support struts 1400 extending from the bottom wall 1308 to the top wall 1304 for structural support.

Each inlet 1302 includes a horizontal tip 1500 and a vertical conduit 1502. The horizontal tips 1500 receive fluid sodium from the strings 116, which then slowly moves to the vertical conduits 1502. The vertical conduits 1502 are configured such that the sodium drips down through the vertical conduits 1502 and out terminals 1504 located at the bottom of each vertical conduit 1502. The inlets 1302 thereby cause droplets of fluid sodium to fall from the terminals 1504 into the chamber 1300 for example onto the splash-prevention members 1402, through the volume of the chamber 1300 (e.g., through the inert gas provided via gas inlet 1310). In some embodiments, the pressure of the inert gas provided to the aggregator 114 via the gas inlet 1310 can be controlled (e.g., adjusted, regulated, modulated, etc.) to facilitate the formation of droplets of the fluid sodium at the terminals 1504. For example, a controller can measure or calculate the pressure differential across the terminals 1504 and adjust the pressure of the pressurized gas provided via the gas inlet 1310 (e.g., by operating a pump or other pressure control device) to maintain the pressure differential at a setpoint or target level that promotes droplet formation. The inlets 1302 may include electrically isolating materials, fittings, etc. to electrically decouple the horizontal tips 1500 from the chamber 1300.

Because the fluid enters the chamber 1300 as droplets falling through an inert gas (e.g., a non-conductive gas) or other electrically insulating fluid, the fluid does not provide a conductive path back from the interior of the chamber 1300 to the strings 116 or vice versa. Additionally, even when droplets are falling from multiple inlets 1302 simultaneously, the droplets are electrically isolated from one another such that no electrical connection is created between different inlets 1302. The aggregator 114 thus aggregates fluid sodium at the outlet 1306 of the aggregator 114 while preventing electrical communication between the different strings 116 or, in various embodiments, any various fluid sources providing conductive fluid to the multiple inlets 1302.

### Sodium Manifold

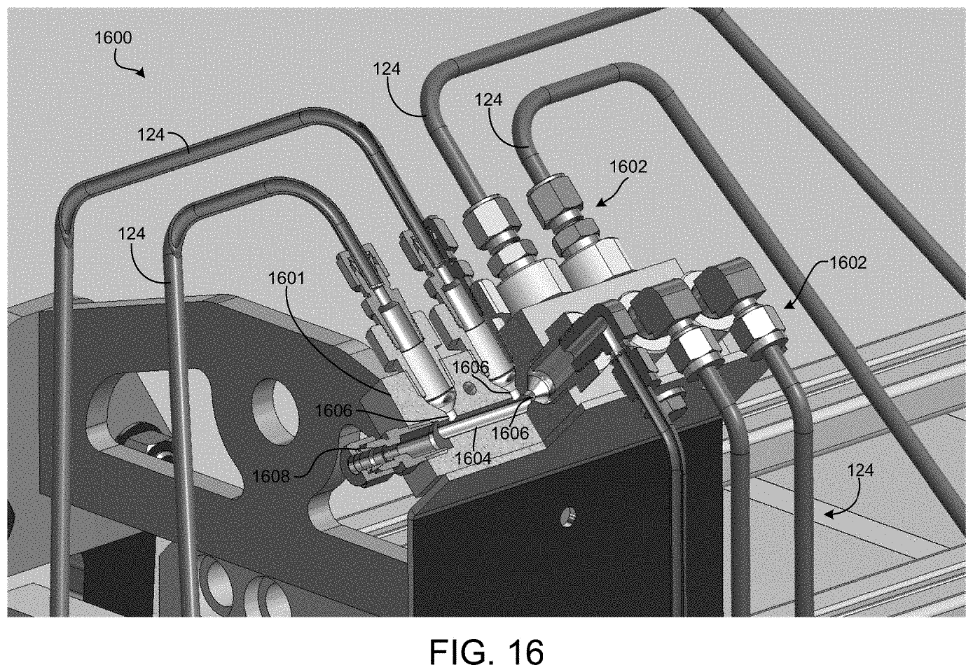

Referring now to FIG. 16, a cut-away perspective view of a manifold 1600 that can be used with the system 100 is shown, according to some embodiments. The manifold 1600 can be used in place of the distributor 112 as illustrated in FIGS. 1-2 and 9-12 and/or the aggregator 114 as illustrated in FIGS. 1-2 and 13-15 in any of the embodiments described herein. The manifold 1600 can be configured to distribute fluid to multiple strings 116 from a common source without creating electrical connections between the strings 116 while a voltage is provided across the stack assembly 110. The manifold 1600 can be configured to aggregate fluid received from multiple strings 116 and provide the aggregated fluid to a common source without creating electrical connections between the strings 116 while a voltage is provided across the stack assembly 110. In some embodiments, the manifold 1600 does not keep the strings 116 electrically isolated from each other but can still be used to prime the strings 116 during a startup phase of system operation and/or purge the strings 116 during a shutdown phase of system operation when an electrical shunt break is not required. Alternatively, the manifold 1600 can be configured to keep the strings 116 electrically isolated from each other by preventing electrical current from flowing between the strings 116 via the electrically conductive fluid within the manifold 1600 and/or via the physical structure of the manifold 1600, as described below.

The manifold 1600 includes a body 1601 and multiple nozzles 1602 extending from the body 1601 (e.g., eight nozzles 1602). The nozzles 1602 are connected to tubing 124, such that each nozzle 1602 is fluidly communicable with one string 116 (similar to the depiction of FIGS. 1-2), for example with each nozzle 1602 connected to one tube or pipe as shown in FIG. 16. In some embodiments, the manifold 1600 can create electrical shunt breaks (e.g., air gaps, gaps of an electrically insulating fluid, etc.) that break up the streams of the electrically conductive fluid by forcing the electrically conductive fluid within the manifold 1600 to break into individual droplets or other non-continuous fluid streams when passing through the nozzles 1602. The nozzles 1602 can be oriented in a “V” shape as shown in FIG. 16 or alternatively could be oriented vertically to allow droplets of the electrically conductive fluid to drip vertically through the air gaps. In some embodiments, the nozzles 1602 are made of an electrically insulating material to prevent electric current from flowing between separate strings 116 through the physical structure of the manifold 1600, similar to the distributor 112 and/or the aggregator 114 as previously described.

The body 1601 includes a central conduit (bore, channel, passage, opening, etc.) 1604. The central conduit 1604 is arranged to align with internal tips 1606 of the nozzles 1602. The central conduit 1604 is communicable with a port 1608 which can be connected to source of and/or receptacle for sodium (e.g., external sodium source 404, sodium storage vessel 600, some combination thereof), for example via tubing (tube, pipe, etc.). Sodium can thus flow to or from nozzles 1602 via the central conduit 1604 and internal tips 1606.

The manifold 1600 can facilitate priming of the system 100 by distributing sodium received at the port 1608 substantially evenly to the multiple nozzles 1602. In such scenarios, sodium flows in through the port 1608 and along the central conduit 1604 to the internal tips 1606, where the sodium enters the nozzles 1602. Pressure/flow of the sodium can push the sodium upwards through the nozzles 1602 and into the tubing 124. A small orifice in each nozzle 1602 can be included to provide back pressure that ensures flow into all of the nozzles 1602. The internal tips 1606, nozzles 1602, central conduit 1604, etc. can also be sized to create a choked flow effect that ensures substantially even flow to each of the nozzles 1602. At the end of a priming stage, sodium stops flowing to or into the central conduit 1604 via the port 1608 (e.g., due to an end to operation of a pump driving sodium from an external source, etc.). Sodium can then run downwardly from the nozzles 1602 and into the central conduit 1604 via the internal tips 1606.

In some embodiments, the manifold 1600 can also facilitate aggregation of sodium from the strings 116 at the conduit 1604. For example, sodium may flow to the nozzles 1602 via the tubing 124 at a rate at which droplets of sodium are formed at an outer orifice of the inner tips 1606 proximate the central conduit 1604 and then drip (separately and through an air gap, for example) into the central conduit 1604. Alternatively or additionally, the nozzles 1602 may cause droplets of sodium to form proximate the tubing 124 (e.g., at reduced diameter portions of the nozzles 1602 connected to the tubing 124) and then drip through air gaps within the nozzles 1602 between the tubing 124 and the inner tips 1606. The sodium may then flow through the inner tips 1606 and into the central conduit 1604. The nozzles 1602 may thereby be configured to provide aggregation of sodium from the tubing 124 at the central conduit 1604 while maintaining electrical disconnection between the sodium in different strings 116 (and different sections of tubing 124).

In some embodiments, the manifold 1600 can distribute sodium to the strings 116 from the external sodium source 404 and/or the sodium storage vessel 600 when operating in flow battery discharging mode (i.e., when consuming sodium to produce electricity). It is contemplated that the manifold 1600 can be used or modified to provide electrical isolation between the strings 116 in flow battery discharging mode, for example, by creating electrical shunt breaks within the nozzles 1602. In some embodiments, the nozzles 1602 have an inverted “V” shape similar to the subset of the nozzles 1602 in the foreground of FIG. 16 with each nozzle 1602 having a pair of legs that extend downward from a center point at the middle of the inverted “V” shape. The end of each leg of the nozzles 1602 may include a flow restrictor such as an orifice (e.g., similar to the internal tips 1606) having a smaller diameter than the conduit that passes through the nozzles 1602. Such a configuration may cause the sodium to pool within the nozzles 1602 and form droplets at the flow restrictors when exiting the nozzles 1602 in either direction. The droplets may drip from the flow restrictors through air gaps below the flow restrictors, thereby providing a dual-direction shunt break.

In some embodiments, the system 100 can be configured to control (e.g., adjust, regulate, modulate, etc.) the pressure of the fluid sodium within the nozzles 1602 and/or within the central conduit 1604 to facilitate the formation of droplets of the fluid sodium at the flow restrictors or other orifices within the manifold 1600. For example, a controller can measure or calculate the pressure differential across the flow restrictors and adjust the pressure of the fluid sodium within the central conduit 1604 (e.g., by providing a pressurized gas to the central conduit 1604, similar to the configuration of the distributor 112 and the aggregator previously described). The controller can operate a pump or other pressure control device for the sodium and/or the pressurized gas to maintain the pressure differential at a setpoint or target level that promotes droplet formation within the manifold 1600 at one or both ends of the nozzles 1602.

Flow Battery Mode with Aggregated Storage

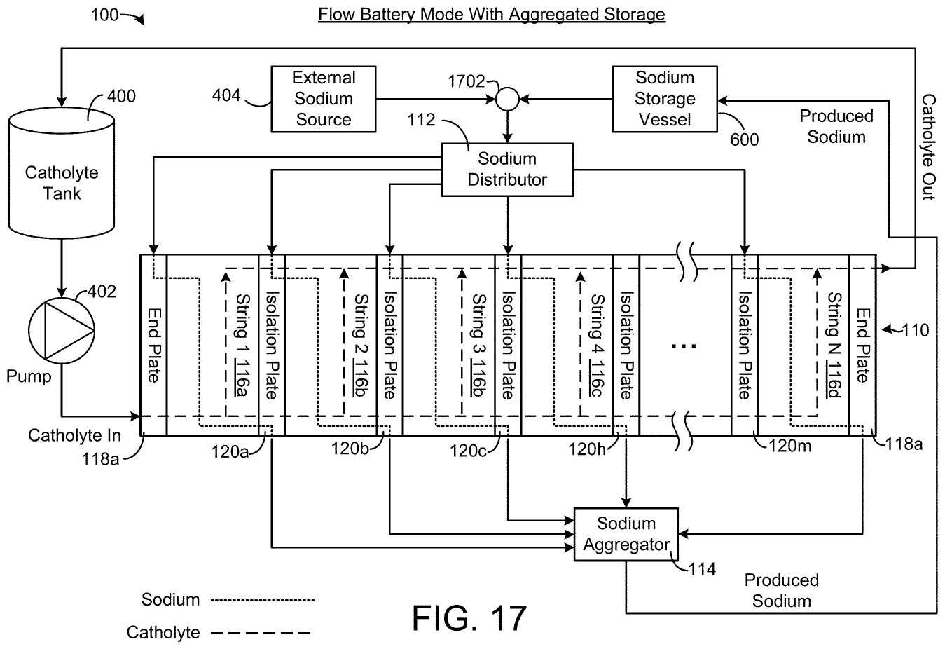

Referring now to FIG. 17, an illustration of the system 100 arranged in a flow battery mode with aggregated storage is shown, according to some embodiments. Sodium produced during a charging mode flows out of the stack assembly 110 to a sodium aggregator 114, which aggregates the sodium in a sodium storage vessel 600 as described in more detail with reference to FIG. 6. As shown in FIG. 17, the sodium storage vessel 600 is connected back to the stack assembly 110 via the sodium distributor 112 such that the produced sodium can flow back into the strings 116 of the stack assembly 110 during a discharging mode. The produced sodium from the sodium storage vessel 600 can thereby loop back into the stack assembly 110 to provide discharge of stored energy from the sodium.

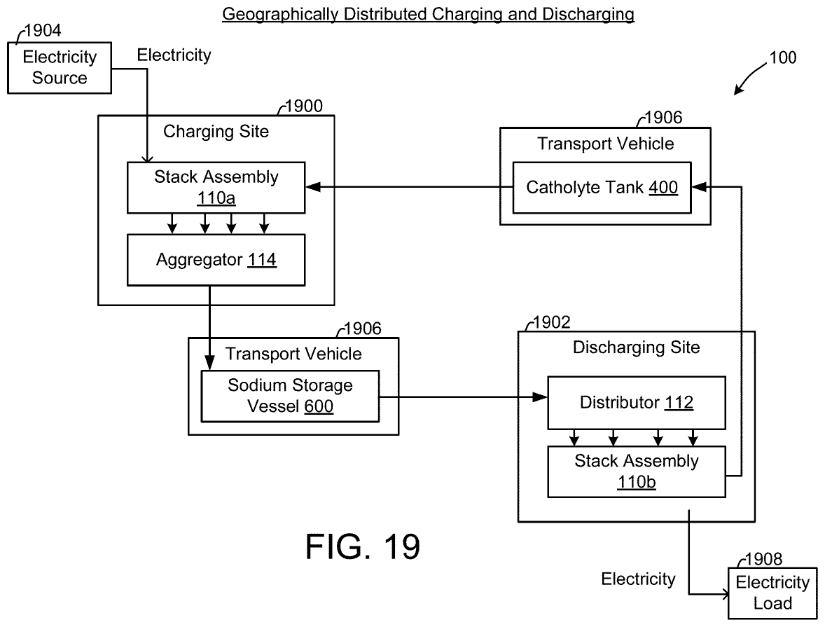

Although the sodium distributor 112 and the sodium aggregator 114 are shown in FIG. 17, it is contemplated that one or both of these components can be swapped out for the sodium manifold 1600. In some embodiments, the distributor 112 can be implemented as an inverted version of the aggregator 114 shown in FIGS. 1-2 and 13-15. Additionally, it is contemplated that the sodium distributor 112 or the aggregator 114 can be omitted from the configuration shown in FIG. 17 to provide a version of the system 100 that operates in charging mode only (i.e., by omitting the distributor 112) or a system that operates in discharging mode only (i.e., by omitting the aggregator 114). Examples of systems that specialize in charging or discharging are described in greater detail with reference to FIG. 19. These and other modifications can be made not just in the embodiment shown in FIG. 17 but also for any of the other embodiments described herein.

In operation, the distributor 112 is configured to disaggregate (e.g., distribute, split up, etc.) the sodium stored in sodium storage vessel 600 into separate streams of sodium provided to the separate strings 116. To enable voltage steps at each string 116, the distributor 112 provides electrical isolation between the separate streams of sodium provided to the separate strings 116. As with other embodiments, the distributor 112 may be a sodium distribution drip feeder configured to release droplets of molten sodium metal from an upper portion of the distributor 112 such that the droplets of molten sodium metal fall through an electrically insulating fluid (e.g., inert gas) within the distributor 112 into a plurality of electrically isolated compartments located along a lower portion of the distributor 112 and connected to separate tubing running to the multiple strings 116.

In some embodiments, the distributor 112 is configured to additionally or alternatively receive sodium from an external source 404, for example during an initial priming phase when the sodium storage vessel 600 may be empty of sodium. As shown in FIG. 17, a valve 1702 is arranged along a flow path of sodium and is operable to select whether the distributor 112 receives sodium from the external source 404 or the sodium storage vessel 600. In some embodiments, valve 1702 may also have an off position in which neither the external source 404 nor the sodium storage vessel 600 are fluidly connected to the sodium distributor 112. It is contemplated that the valve 1702 may also be capable of electrically insulating the sodium distributor 112, the sodium storage vessel 600, and/or the external source 404 from each other to further provide the electrical shunt break (i.e., disruption of unwanted electric current) in system 100.

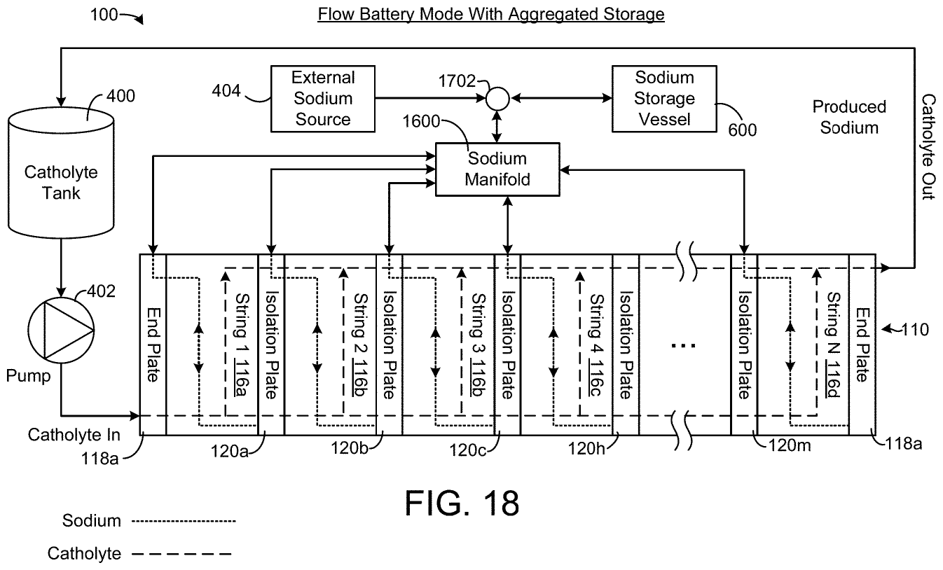

Referring now to FIG. 18, an illustration of another implementation of the system 100 providing a flow battery mode is shown, according to some examples. In the example of FIG. 18, the sodium manifold 1600 is shown and is capable of providing both aggregation of sodium produced by the strings 116 (for provision into the sodium storage vessel 600) and distribution or disaggregation of sodium from the sodium storage vessel 600 or an external source 404. As described above, the manifold 1600 can perform the function of the distributor 112 as shown in FIGS. 9-12 and/or the aggregator 114 as shown in FIGS. 13-15 depending on the direction of the sodium flow through the manifold 1600. As such, the manifold 1600 is a versatile component capable of providing a dual-direction shunt break between the strings 116.

In the example of FIG. 18, the strings 116 can first be primed by distributing, by the manifold 1600, sodium from the external sodium source 404 into the various strings 116. It is contemplated that the strings 116 could also be primed from the sodium stored in the sodium storage vessel 600 if any sodium is contained therein. However, in some cases the sodium storage vessel 600 may initially be empty and only contains sodium after the sodium has been produced by the strings 116. After priming the strings 116, the system 100 can be operated in a charging mode or sodium production mode where the sodium is produced in the strings 116 and flows to the manifold 1600. The manifold 1600 aggregates the sodium from the separate strings 116 for storage in the sodium storage vessel 600 while maintaining electrical isolation between the sodium in the separate strings 116. Produced sodium is thereby stored in the sodium storage vessel 600. While it is contemplated that the produced sodium could also be stored in the external sodium source 404, in some embodiments the external sodium source 404 is used only to supply the priming sodium and is not used after the strings 116 have been primed.

The system 100 can also be operated in a discharging mode, where sodium from the sodium storage vessel flows (e.g., drips) back through the manifold 1600 to the multiple strings 116. The manifold 1600 can distribute the sodium substantially evenly to the strings 116 while maintaining electrical isolation between the strings 116 (e.g., by dripping sodium through air gaps as described elsewhere herein). Sodium thereby reaches the strings 116, where it is consumed in an electro-chemical reaction within strings 116 that generate electricity provided as an output from the stack assembly 110. As the strings 116 empty of sodium while operating in the discharging mode, more space may become available within the strings 116. The sodium manifold 116, sodium storage vessel 600, and/or the external sodium source 404 may be positioned physically above the strings 116 such that gravity causes downward flow of sodium into the strings and a powered pump is not required to deliver sodium to the strings 116. In the example of FIG. 18, each string 116 includes one open sodium port through which sodium both enters and exits the string 116 depending on operating mode. The other sodium ports used in other embodiments can be sealed or closed as they are not needed in this configuration.

### Geographically Distributed Charging and Discharging

Referring now to FIG. 19, a diagram depicting a geographically distributed implementation of system 100 is shown, according to some embodiments. In some embodiments, the components of system 100 can be distributed across multiple locations or physical sites to allow for charging at one site and discharging at another site. As discussed above, the system 100 can be used in a charging mode to store electricity (in the form of valence electrons of sodium atoms) and a discharging mode to produce electricity (by reactions allowing release of said valence electrons). The implementation of FIG. 19 illustrates transportation of produced sodium atoms from a first location (shown as charging site 1900) to a second location (shown at discharging site 1902), thereby also transporting the stored electricity (i.e., electricity stored as chemical energy in the produced sodium) from the first location to the second location. At the second location, a portion of system 100 can be used to harvest the stored energy from the sodium atoms in order to output electricity. By doing so, electricity is transferred from the first location to the second location.

As one example scenario, the charging site 1900 can be located in a geographic region with high availability to green, renewable, non-polluting, non-carbon-emitting, and/or low-cost or free energy (e.g., areas with high geothermal activity, areas with high solar irradiance, areas with high winds, areas with existing energy production facilities) while the discharging site 1902 can be located at a geographic region without such energy availability (e.g., areas only having access to fossil-fuel-based energy production, areas disconnected from energy grids, etc.). Transportation of sodium from the charging site 1900 to the discharging site 1902 in such scenarios can reduce pollution (e.g., reduce carbon emissions, reduce greenhouse gases, etc.) and cost savings by allowing the discharging site 1902 to benefit from the green, renewable, non-polluting, non-carbon-emitting, and/or low-cost or free energy available at the charging site 1900.

In some embodiments, the charging site 1900 and the discharging site 1902 may be the same physical site. In this scenario, the produced sodium can be transported off-site (or to a storage location or building within the site) for storage and then returned to the site at a later time or date. For example, the sodium can be generated/stored, transported, and used to generate electricity on a seasonal basis (e.g., charging during a dry season of high solar availability and discharging during a rainy season of low solar availability, charging during low-demand seasons and discharging during high-demand seasons, etc.).

As shown in FIG. 19, the charging site 1900 receives energy from electricity source 1904. The electricity source is connected to a first instance of the stack assembly 110 (shown as stack assembly 110a) and used to provide a voltage across the stack assembly 110a. Energy from the electricity source is used to drive reactions which pull sodium ions from the catholyte and add valence electrons to produce sodium atoms (e.g., as shown in FIG. 21) such that extra electrons from electricity source 1904 are stored in the sodium atoms. Sodium then flows out of the stack assembly 110a to aggregator 114, for example as illustrated in FIG. 6 with reference to the sodium production mode of the stack assembly 110. The aggregator 114 aggregates the sodium into a sodium storage vessel 600 while preventing current flows between strings 116 as described in detail above. As with the other embodiments, the aggregator 114 could be replaced with the manifold 1600.

In the example of FIG. 19, the sodium storage vessel 600 is positioned on (e.g., integrated with, loadable onto, etc.) a transport vehicle 1906. The transport vehicle 1906 may be a truck (or other vehicle that drives on roadways), train, ship, plane, etc. The transport vehicle 1906 is configured to move from the charging site 1900 to the discharging site 1902 while carrying the sodium in the sodium storage vessel 600. In other embodiments, the transport vehicle 1906 is replaced with a pipeline connecting the charging site 1900 to the discharging site 1902 through which the sodium 600 can flow. The transport vehicle 1906 and/or the sodium storage vessel 600 may be robustly designed to prevent leaks, spills, etc. of the sodium during transportation, including in event of a crash, collision, etc. of the transport vehicle 1906. The sodium storage vessel 600 is preferably made of a material that ensures long-term stability of the sodium.

When the transport vehicle 1906 reaches the discharging site 1902, the sodium storage vessel 600 is connected to the distributor 112, which serves a second instance of the stack assembly (shown as stack assembly 110b). The distributor 112 distributes the sodium from the sodium storage vessel 600 to different strings of the stack assembly 110b while preventing current flow between the strings through the sodium. As with the other embodiments, the distributor 112 could be replaced with the manifold 1600. The stack assembly 110b operates in a discharging mode, such that the sodium atoms give up their valence electrons and Na⁺ ions flow into the catholyte. The released valence electrons flow out of the stack assembly as electricity provided to an electricity load 1908. The electricity load 1908 may be an energy grid, a building electrical system, a plant, a particular unit or set of equipment (e.g., manufacturing equipment), etc. in various embodiments.

FIG. 19 further illustrates that the catholyte (now enriched with Na⁺ ions) can be provided back onto the transport vehicle 1906 (or a different transport vehicle), for example in a catholyte tank 400. The transport vehicle 1906 then transports the catholyte to the charging site 1900, where the catholyte is provided to the stack assembly 110a of the charging site 1900. In some embodiments, catholyte is also transported from the charging site 1900 to the discharging site 1902. This arrangement allows sodium (atoms and ions) to loop through both the charging site 1900 and the discharging site 1902 such that no or little waste (e.g., by-products, etc.) is created. Sodium-based energy transportation can thereby be provided using the geographically distributed system of FIG. 19.

### CONFIGURATION OF EXEMPLARY EMBODIMENTS

As utilized herein with respect to numerical ranges, the terms “approximately,” “about,” “substantially,” and similar terms generally mean+/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

What is claimed is:

1. A molten metal battery system comprising:
a plurality of secondary cells electrically connected in series with each other and comprising a plurality of molten metal anodes arranged fluidly in parallel with each other;
a plurality of electrically isolated molten metal reservoirs, each of the molten metal reservoirs fluidly connected to a corresponding secondary cell of the plurality of secondary cells and configured to exchange molten metal with the corresponding secondary cell while preventing electrical shunt current from flowing between the plurality of secondary cells via the molten metal.

2. The molten metal battery system of claim 1, wherein the molten metal comprises molten sodium metal.

3. The molten metal battery system of claim 1, wherein the molten metal flows passively between the plurality of electrically isolated molten metal reservoirs and the plurality of secondary cells without requiring a powered component to drive flows of the molten metal.

4. The molten metal battery system of claim 1, further comprising a molten metal distributor fluidly connected in series between an external molten metal source and the plurality of secondary cells and configured to distribute the molten metal from the external molten metal source to the plurality of molten metal anodes while preventing the electrical shunt current from flowing between the plurality of secondary cells via the molten metal.

5. The molten metal battery system of claim 4, wherein the molten metal distributor comprises a molten metal distribution drip feeder configured to:
release droplets of the molten metal from an upper portion of the molten metal distributor; and
allow the droplets of the molten metal to fall through an electrically insulating fluid within the molten metal distributor into a plurality of electrically isolated compartments located along a lower portion of the molten metal distributor.

6. The molten metal battery system of claim 4, wherein the molten metal distributor comprises:
a molten metal inlet fluidly connected to the external metal source and configured to receive the molten metal into the molten metal distributor from the external metal source;
a plurality of compartments electrically isolated from each other; and
a plurality of molten metal outlets each fluidly connected to a corresponding compartment of the plurality of compartments and configured to deliver the molten metal from the corresponding compartment to a corresponding secondary cell of the plurality of secondary cells.

7. The molten metal battery system of claim 6, wherein the molten metal distributor comprises a plurality of electrically isolating fittings coupled to the plurality of molten metal outlets and configured to prevent electrical shunt current from flowing between the plurality of secondary cells via a structure of the molten metal distributor.

8. The molten metal battery system of claim 1, wherein the plurality of secondary cells are configured to operate as a flow battery in:
a charging mode in which the plurality of secondary cells consume electricity and produce the molten metal within the plurality of molten metal anodes; and
a discharging mode in which the plurality of secondary cells consume the molten metal within the plurality of molten metal anodes and produce electricity.

9. The molten metal battery system of claim 1, wherein each of the plurality of secondary cells comprises:
a cathode compartment containing a catholyte fluid;
an anode compartment containing a molten metal anode of the plurality of molten metal anodes; and
an ion-selective membrane positioned between the cathode compartment and the anode compartment and configured to selectively transport metal ions between the cathode compartment and the anode compartment.

10. The molten metal battery system of claim 9, wherein the plurality of secondary cells are configured to operate in a charging mode comprising:
transporting the metal ions from the cathode compartment, through the ion-selective membrane, to the anode compartment; and
reducing the metal ions within the anode compartment by combining the metal ions with electrons to produce the molten metal.

11. The molten metal battery system of claim 9, wherein the plurality of secondary cells are configured to operate in a discharging mode comprising:
oxidizing the molten metal within the anode compartment to form the metal ions and discharge electrons; and
transporting the metal ions from the anode compartment, through the ion-selective membrane, to the cathode compartment.

12. The molten metal battery system of claim 1, comprising an isolation plate located between adjacent secondary cells of the plurality of secondary cells and configured to electrically isolate the adjacent secondary cells from each other.

13. The molten metal battery system of claim 1, comprising a plurality of battery strings electrically connected in series with each other;
wherein each battery string of the plurality of battery strings comprises multiple unit cells including one of the plurality of secondary cells one or more additional secondary cells comprising one or more additional molten metal anodes.

14. The molten metal battery system of claim 13, wherein:
the multiple unit cells within each string are electrically connected in parallel with each other; and
the molten metal anodes within each string are maintained at substantially equal electrical potentials.

15. The molten metal battery system of claim 13, wherein:
each string of the plurality of strings comprises a plurality of cathodes and a plurality of molten metal anodes arranged in an alternating sequence; and
at least one of the plurality of cathodes or the plurality of molten metal anodes is shared by adjacent unit cells of the multiple unit cells.

16. A molten metal battery system comprising:
a plurality of secondary cells electrically connected in series with each other and comprising a plurality of molten metal anodes arranged fluidly in parallel with each other;
a molten metal storage vessel configured to store molten metal; and
a molten metal aggregator fluidly connected in series between the plurality of secondary cells and the molten metal storage vessel and configured to deliver the molten metal from the plurality of molten metal anodes to the metal storage vessel while preventing electrical shunt current from flowing between the plurality of secondary cells via the molten metal.

17. The molten metal battery system of claim 16, wherein the molten metal comprises molten sodium metal.

18. The molten metal battery system of claim 16, wherein the molten metal flows passively between the plurality of secondary cells, the molten metal aggregator, and the molten metal storage vessel without requiring a powered component to drive flows of the molten metal.

19. The molten metal battery system of claim 16, wherein the molten metal aggregator comprises:
a plurality of molten metal inlets, each molten metal inlet of the plurality of molten metal inlets fluidly connected to a corresponding secondary cell of the plurality of secondary cells and configured to receive the molten metal from the corresponding secondary cell;
a molten metal collection chamber configured to receive the molten metal from each of the plurality of molten metal inlets and combine the molten metal into a single pool; and
a molten metal outlet fluidly connected to the molten metal storage vessel and configured to deliver the molten metal from the molten metal collection chamber to the molten metal storage vessel.

20. The molten metal battery system of claim 17, wherein the molten metal aggregator comprises a plurality of electrically isolating fittings coupled to the plurality of molten metal inlets and configured to prevent electrical shunt current from flowing between the plurality of secondary cells via a structure of the molten metal aggregator.

21. The molten metal battery system of claim 16, wherein the molten metal aggregator comprises a molten metal aggregation drip feeder configured to:
release droplets of the molten metal from an upper portion of the molten metal aggregator; and
allow the droplets of the molten metal to fall through an electrically insulating fluid into a molten metal collection chamber located along a lower portion of the molten metal aggregator.

22. The molten metal battery system of claim 16, wherein each of the plurality of secondary cells comprises:
a cathode compartment containing a catholyte fluid;
an anode compartment containing a molten metal anode of the plurality of molten metal anodes; and
an ion-selective membrane positioned between the cathode compartment and the anode compartment and configured to selectively transport metal ions between the cathode compartment and the anode compartment.

23. The molten metal battery system of claim 22, wherein the plurality of secondary cells are configured to operate as a molten metal production system by:
transporting the metal ions from the cathode compartment, through the ion-selective membrane, to the anode compartment;
reducing the metal ions within the anode compartment by combining the metal ions with electrons to produce the molten metal; and
discharging the molten metal to the molten metal storage vessel.

24. The molten metal battery system of claim 16, comprising an isolation plate located between adjacent secondary cells of the plurality of secondary cells and configured to electrically isolate the adjacent secondary cells from each other.

25. The molten metal battery system of claim 16, comprising a plurality of battery strings electrically connected in series with each other;
wherein each battery string of the plurality of battery strings comprises multiple unit cells including one of the plurality of secondary cells one or more additional secondary cells comprising one or more additional molten metal anodes.

26. The molten metal battery system of claim 25, wherein:
the multiple unit cells within each string are electrically connected in parallel with each other; and
the molten metal anodes within each string are maintained at substantially equal electrical potentials.

27. The molten metal battery system of claim 25, wherein:
each string of the plurality of strings comprises a plurality of cathodes and a plurality of molten metal anodes arranged in an alternating sequence; and
at least one of the plurality of cathodes or the plurality of molten metal anodes is shared by adjacent unit cells of the multiple unit cells.

28. The molten metal battery system of claim 16, further comprising a molten metal distributor fluidly connected in series between an external molten metal source and the plurality of secondary cells and configured to distribute the molten metal from the external molten metal source to the plurality of molten metal anodes while preventing the electrical shunt current from flowing between the plurality of secondary cells via the molten metal.

29. The molten metal battery system of claim 28, wherein the molten metal distributor comprises a molten metal distribution drip feeder configured to:
release droplets of the molten metal from an upper portion of the molten metal distributor; and
allow the droplets of the molten metal to fall through an electrically insulating fluid within the molten metal distributor into a plurality of electrically isolated compartments located along a lower portion of the molten metal distributor.

30. The molten metal battery system of claim 28, wherein the molten metal distributor comprises:
a molten metal inlet fluidly connected to the external metal source and configured to receive the molten metal into the molten metal distributor from the external molten metal source;
a plurality of compartments electrically isolated from each other; and
a plurality of molten metal outlets each fluidly connected to a corresponding compartment of the plurality of compartments and configured to deliver the molten metal from the corresponding compartment to a corresponding secondary cell of the plurality of secondary cells.

31. The molten metal battery system of claim 30, wherein the molten metal distributor comprises a plurality of electrically isolating fittings coupled to the plurality of molten metal outlets and configured to prevent electrical shunt current from flowing between the plurality of secondary cells via a structure of the molten metal distributor.
